(19) United States
(12) Patent Application Publication
(10) Pub. No.: US 2011/0141115 A1
(43) Pub. Date: Jun. 16, 2011

(54) INTERACTIVE METHOD FOR DISPLAYING INTEGRATED SCHEMATIC NETWORK PLANS AND GEOGRAPHIC MAPS

(75) Inventors: Ulrik Brandes, Taegerwilen (CH); Joachim Boettger, Konstanz (DE); Oliver Deussen, Konstanz (DE); Hendrik Ziezold, Konstanz (DE)

(73) Assignee: UNIVERSTITAET KONSTANZ, Konstanz (DE)

(21) Appl. No.: 12/920,750

(22) PCT Filed: Mar. 4, 2009
(86) PCT No.: PCT/EP09/01529

§ 371 Date: Jan. 12, 2011

(30) Foreign Application Priority Data
Mar. 4, 2008 (DE) 102008012411.7

(51) Int. Cl. G06T 3/00; G06T 11/00

(52) U.S. Cl. 345/428; 345/634; 345/610

(57) ABSTRACT

Embodiments relate to a computer-implemented method, system, and computer program product for dynamically integrating a geographic map representation and a schematic map representation. The method can include providing a geographic map representation have one or more starting positions associated with one or more destinations in a schematic map representation, calculating an interpolating and continuous display function by applying a warping method in connection with a method for monitoring overlap to the starting positions and the destinations; and displaying a dynamic or interactive integrated map representation by dynamically applying the display function to the geographic map representation and/or the schematic map representation so that each map representation is distorted according to a selected distortion factor, wherein the integrated map representation represents at least elements and/or parts of both the geographic map representation and the schematic map representation, independent of the selected distortion factor.

The present invention relates in general to a computer-supported representation of two-dimensional data. More specifically, the present invention relates to a computer-implemented method, a computer program product, a system and a display for dynamic and/or interactive integration of schematic map data and geographic map data.

When a person would like to go from one location (i.e., point) to another location (i.e., point) in a city and uses a subway, for example, to do so, that person would presumably use two plans—first, a schematic map, i.e., a (network) plan for the subway, and second, a geographic map of the city. On the one hand, the schematic map is optimized with regard to the readability of information describing the structure of connections and node points of a transportation system, for example. However, schematic maps stored electrically, electronically, i.e., in a computer and displayed via an output device (e.g., a display or screen) show very little information or none at all describing the details in the surroundings of a subway station, for example. On the other hand, the geographic map is suitable for representing detailed information such as individual roads and road intersections in a geographically correct manner (i.e., corresponding to the real world) but is not suitable for giving a rapid overview of possible subway connections from one station to another, for example.

First of all, there are (electronic and computer-supported) geographic maps which have annotations pertaining to subway stations and subway lines, for example, but in which the schematic character of a schematic map is completely lost because the schematic map has been adapted to the geographic map. Consequently, with such annotated maps, even if they are present in electronic form, it is impossible to select a degree of detail as a function of user-defined specifications and/or the geographic position of a user. In other words, with such maps it is impossible to switch dynamically and/or interactively between different gradations in the transition from a geographic map representation to a schematic map representation (or vice-versa). Consequently, such maps are static.

Secondly, in the case of a subway station, for example, there are (electronic and/or computer-supported) schematic maps which are annotated and/or enriched by the addition of additional geographic data concerning the surroundings of the subway station. However, then it is necessary to adapt a schematic map to make available space for a subway station and its geographic surroundings on the map. Consequently, since such maps are not dynamic, it is impossible to display just any starting point but instead only the (direct) surroundings of a subway station may be displayed in a detailed (and cartographically correct) view.

The object of the invention is to provide a computer-implemented method, system and computer program product suitable for generating an electronic and/or computer-based map and/or map display, which dynamically and/or interactively integrates a schematic map representation and/or a (network) plan and a geographic map representation.

This object is achieved according to the present invention through the features of the independent claims. Preferred embodiments of the invention are the subject matter of the dependent claims.

According to the invention, a computer-implemented method for dynamic integration of a geographic map representation and a schematic map representation (and/or a computer-implemented dynamic and/or interactive method based on a geographic map representation and a schematic map representation) is provided, this method comprising:
providing a geographic map representation (and/or map and/or map data) having one or more starting positions (and/or starting points), which are assigned to one or more destination positions (and/or destination points) in a schematic map representation (and/or map and/or map data);
calculating an interpolating and continuous mapping function by applying a warping method to (and/or using) the starting position(s) and the destination position(s) (as reference points) associated with a method for overlap control; and
displaying a dynamically and/or interactively integrated map representation (preferably a display of a dynamic and/or interactive representation integrating two maps that are optimized for different use modes, wherein the optimized maps comprise the geographic map representation and the schematic map representation) by dynamic application of the mapping function to the geographic map representation and/or the schematic map representation, so that the respective map representation is distorted according to a selected distortion factor, wherein the integrated map representation represents and/or contains at least elements and/or parts of the geographic map representation and the schematic map representation independently of the selected distortion factor.

Accordingly, a dynamic and/or interactive method for generating and/or displaying an integrated (map) representation is provided, based in particular on integration of a geographic map representation and a schematic map representation. Consequently, a dynamic and/or interactively integrated (map) representation is generated and/or calculated and displayed, comprising in particular an integrated representation based on maps optimized for at least two different use modes. Such maps optimized for certain use modes comprise, for example, geographic map representations and schematic map representations.

Consequently, unlike a simple crossfade of a geographic map with a schematic map, an integrated representation of both maps is generated and displayed, so that both maps are displayed in an integrated form independently of the degree of distortion selected, in particular even if the geographic representation and/or the schematic representation is completely distorted, i.e., the other representation, respectively, is so greatly distorted that the selected starting positions and/or destination positions are shifted to the other positions, respectively. In other words, the integrated map representation in the two extreme positions (i.e., the geographic map is displayed in rectified form and the schematic map is displayed in distorted form or vice-versa) comprises both map representations, which are displayed together (at least partially).

Data of the geographic map representation and the schematic map representation are preferably available in the form of vector data (e.g., in one or more formats selected from US Census TIGER Data Format, OSM data, OpenStreetMap OSM, XML or similar formats), wherein the vector data are stored accordingly in a memory device (e.g., a database) and are accessible via the method. Therefore, not only is a graphic quality ensured at various stages of enlargement and/or various degrees of distortion but also a selection of displayed information and/or elements of the geographic and/or a schematic representation in the integrated representation is made possible, for example, with respect to the level of detail and/or a (semantic) zoom factor. This allows a representation of cartographic entities adjusted with regard to distortion/rectification, enlargement, level of detail and/or zoom factor. For example, subway lines can still be represented and/or displayed in the style of a schematic representation even in a distorted representation of a schematic map. In other words, there is in particular a strict separation of the vector data on which the geographic and schematic map representations are based from their geographic representation as geographic and schematic map representation, i.e., the vector data and/or corresponding metainformation and/or metadata, which can be converted according into the graphic representation, serve as input for the representation (in particular exclusively), while a graphic representation of this data is not input in particular but instead is calculated (in particular exclusively), namely situationally and/or in an interactive manner.

Accordingly, schematic map representations are supplemented by adding geographic map representations, wherein the geographic map representation is distorted accordingly by using suitable image warping techniques. To do so, a set of corresponding (discrete) points is selected as control points and/or reference points for a distortion algorithm (in particular a suitable image warping method in combination with a suitable method for monitoring overlapping in image warping) in both the schematic map representation and in the geographic map representation. The control points represent geographic entities such as subway stations, train stations, signal boxes, water or electric power plants and/or distributors, public utilities and/or squares, roads and/or road intersections in the respective map representations. If the image warping method with overlap control is applied to the corresponding starting positions and destination positions, then a continuous and interpolating mapping function which does not create any overlaps is calculated. This function can now be applied to the schematic map representation and/or the geographic map representation, wherein the selected positions in the respective map representations are then mapped accordingly on the respective other map representation and all the points in between are distributed continuously between these two positions. Due to the fact that the mapping function is interpolated, any desired distortion factor (from a purely schematic map representation to a purely geographic map representation) may be selected for the integrated map. Consequently, the integrated map representation can be adapted accordingly (automatically by means of GPS and/or user-identified system) in a degree of distortion depending on the application.

In other words, a schematic map is annotated and/or enriched with additional data and/or information from a corresponding geographic map without altering the design of the schematic map. Consequently, in contrast with annotation of a geographic map, this method uses schematic data and/or information. In the latter method, the schematic map is adapted to the geographic map. According to the present invention, however, the geographic map is adapted by deformation of the schematic map. By applying the interpolating (and continuous) mapping function, distortion of the schematic map to the geographic map nevertheless remains possible. Consequently, an integrated map representation is generated and/or is displayed on a display screen, wherein the integrated map representation comprises a dynamic and/or interactive representation which integrates two map representations optimized for different use modes (in particular a geographic map representation and a schematic map representation). The different use modes are based on properties of geographic map representations and/or schematic map representations, for example. Geographic map representations are suitable for navigation by foot or by vehicle in a city, for example. Schematic representations are suitable for obtaining and/or using an overview of a public transportation system, for example.

Accordingly, the dynamically and/or interactively integrated map increases the usability of schematic map representations and geographic map representations by merging and/or combining two different navigation levels. Such an integrated map representation is suitable mainly for use in small mobile terminals (e.g., cellular telephone, PDA). The integrated map representation may be interpolated dynamically (linearly) between the purely geographic map representation and the schematic map representation. A comprise between these two map representations is thus also possible.

Consequently, such an integrated map representation is more understandable for the user because he can display both navigation levels (i.e., the level of the schematic map representation and that of the geographic map representation) together in a suitable degree of distortion, i.e., geographic or schematic). Furthermore, the user can select any other degree of distortion for the integrated map representation. Consequently, this also simplifies any interaction of the user with a terminal for display of the integrated map representation. In particular the integrated map representation may also be better adapted (automatically) to the technical specifics of a (mobile) terminal, e.g., resolution, size, color options, etc. of a display of the terminal.

An adaptation of a geographic map to a corresponding schematic map is a difficult technical problem, in particular because there are no distance relationships in the schematic map, so an extrapolation of the geographic points according to the deformation and/or distortion caused by the schematic map is advantageous.

The step of display of an integrated map representation preferably comprises:
display of the dynamically and/or interactively integrated map representation by applying a zoom function coupled with the mapping function to the geographic map representation and/or the schematic map representation.

In addition, the step of applying a zoom function coupled to the mapping function preferably comprises:
dynamic interpolation between the geographic map representation and the schematic map representation by applying the mapping function with simultaneous application of the zoom function, wherein the center of the integrated map representation remains at a constant representation position,
wherein the interpolation is preferably performed linearly.

A dynamic interactive integrated map is generated by coupling a zoom function and an interpolating mapping function for cartographic data (schematic data and/or geographic data), this integrated map being suitable for various navigation needs as well as for display on terminals having small displays or screens.

The method also preferably comprises:
display of the dynamically and/or interactively integrated map representation by applying the mapping function coupled with an enlargement function, which is applicable to a detail of the integrated map representation.

Accordingly, a detail, i.e., a section of the integrated map representation can be displayed in enlarged form, wherein (essentially) the remainder of the integrated map representation remains unchanged. Consequently, the enlargement acts like a lens and/or a magnifying glass around a reference point, for example. If the geographic map in the integrated map representation is distorted, for example, and the schematic map is not displayed in a distorted form (i.e., is essentially rectified), then in an enlarged detail the geographic elements are represented as more rectified and the schematic elements are represented as more distorted accordingly. Consequently, the geographic map representation is represented as rectified locally (in a detail) due to the enlargement function and/or the lens function (at least partially). If this enlargement function is coupled with the mapping function (and/or warping function), then we also speak of a warping lens.

In addition, the method preferably comprises:
calculating a level of detail with regard to selection and/or resolution (in particular with respect to a semantic zoom and/or a geometric zoom) for the integrated map representation, depending on an output device and/or the degree of distortion.

Accordingly, the level of detail may be selected with regard to a selection of information and/or elements such as cartographic entities and/or with respect to the resolution of the integrated map such as the size of a selected detail, for example. This can be accomplished by a user by means of a cursor and/or operating elements on an output device, for example.

Depending on the size of the display of an output device and/or the selected degree of distortion, it is possible to define a level of detail which describes a possible limit up to which a certain set of geographic detail information (e.g., cartographic entities) can still be displayed and/or represented suitably.

In addition, the method preferably comprises:
display of the dynamically and/or interactively integrated map representation by applying the mapping function (preferably by dynamic linear interpolation between the two map representations) coupled to the level of detail with respect to selection and/or resolution and/or the enlargement function, depending on a geographic position and/or the movement of the user.

Accordingly, for the integrated map representation, a level of detail with respect to the selection and/or resolution and/or an enlargement function may be selected (automatically) for a certain detail, i.e., section of the integrated map representation, on the basis of the geographic position and/or movement (in particular a speed at which the user is moving). For example, while driving in the fast lane (e.g., on a highway), a corresponding highway system may be represented schematically in particular (at least in part) in an integrated map (i.e., geographic elements are represented with distortion), whereas when the user is moving more slowly, for example, when the vehicle leaves the highway, an enlarged and geographically less distorted integrated map is displayed, comprising more geographic details (for example, cartographic entities).

The geographic position can be determined (automatically), for example, by means of a geographic positioning system, such as GPS, when a (mobile) output device is used.

The method also preferably comprises:
calculating and displaying distance information (and/or relationships) in the integrated map representation.

In addition, the step of calculating and representing distance information in the integrated map representation preferably comprises:
distorting a regular grid with simultaneous application of the mapping function to the geographic map representation, namely by applying the mapping function to one or more grid points of the grid, and
representing the distance information through isolines in the integrated map representation, namely by calculating the distance from each of the grid points to a corresponding next geographic position in the geographic map representation and applying the warping method to the distorted grid.

Since a schematic map does not contain any distance information that is geographically accurate and an integrated map representation is also distorted into the schematic map, it may be advantageous to incorporate this useful property of geographic map representations into the integrated map representation. This is preferably achieved by extrapolation of the deformations and/or distortions, which occur due to the schematization, with respect to the starting position of the geographic map representation. To do so, in addition to the geographic map representation, a regular grid is distorted accordingly by means of the warping method used and distances between the distorted grid points and the starting positions are calculated and then yield isolines in the (distorted) integrated map representation by applying the warping method, where these isolines describe the distances between the distorted positions and the corresponding starting positions.

According to the present invention, a system for dynamic integration of a geographic map representation and a schematic map representation is provided, said system comprising:
a memory device, which is designed to store a geographic map representation with one or more starting positions, which are assigned to one or more destination positions in a schematic map representation;
a data processing device, which is designed to calculate an interpolating and continuous mapping function, namely by applying a warping method to (and/or using) the starting position(s) and the destination position(s) (as reference points) in combination with a method for overlap control, and
a display, which is designed to represent a dynamically and/or interactively integrated map representation (preferably to represent a dynamic and/or interactive representation integrating two maps that are optimized with respect to different use modes, wherein the optimized maps comprise the geographic map representation and the schematic map representation), namely by dynamic application of the mapping function to the geographic map representation and/or the schematic map representation (preferably by dynamic linear interpolation between the two map representations), so that the respective map representation is distorted according to a selected distortion factor, wherein the integrated map representation represents and/or contains at least elements and/or parts of both the geographic map representation and the schematic map representation, regardless of the selected distortion factor.

Another aspect of the present invention relates to a computer program product, in particular stored on a computer-readable medium or implemented as signal, which, when loaded into the memory of a computer or a computer network and executed by a computer and/or a computer network, causes the computer and/or the computer network to perform an inventive method or a preferred embodiment thereof.

According to the invention, a display of an integrated map representation is also supplied as a dynamic integration of a geographic map representation and a schematic map representation, wherein:
the dynamically and/or interactively integrated map representation is displayed by dynamic application of a mapping function to a geographic map representation (10) having one or more starting positions, which are assigned to one or more destination positions in a schematic map representation, and/or the schematic map representation (preferably by dynamic linear interpolation between the two map representations), so that the respective map representation is distorted according to a selected distortion factor,
the interpolating and continuous mapping function has a warping processing by using the starting positions and the destination positions as reference points combined with an overlap control, and
the integrated map representation contains and/or represents at least elements and/or parts of both the graphic map representation and the schematic map representation, regardless of the selected distortion factor.

Preferred embodiments are described below with respect to accompanying drawings as examples. It is pointed out that even if embodiments are described separately, individual features therefore can be combined to form additional embodiments.

In the drawings:

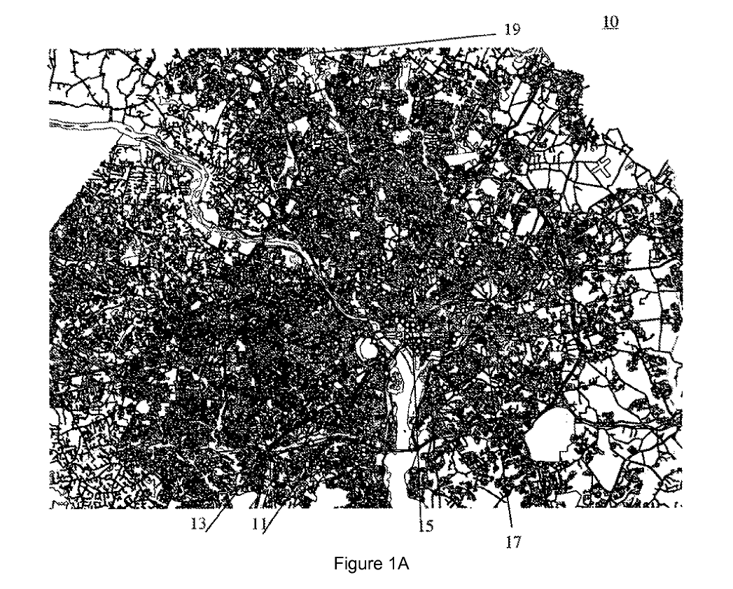

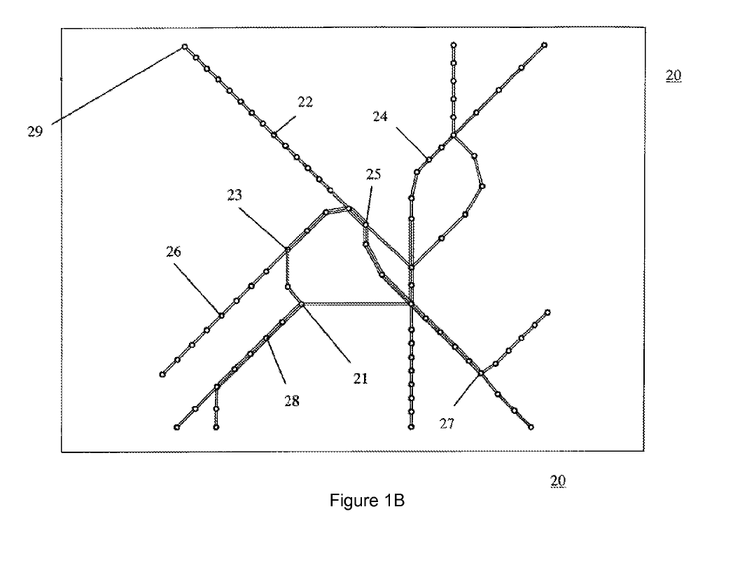

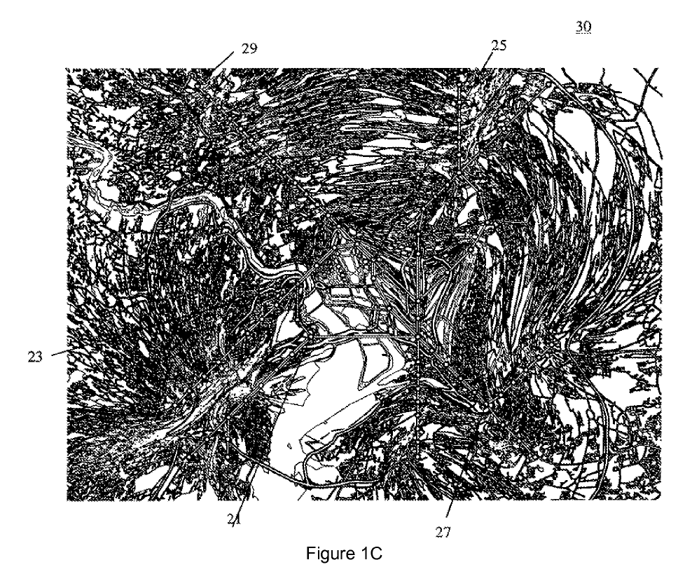

FIG. 1A shows an example of a geographic map of the city of Washington with geographic positions of subway stations of the city.

FIG. 1B shows an example of a schematic map of the subway network plan of the city of Washington with schematic positions of the municipal subway stations.

FIG. 1C shows an example of an annotated schematic map of the subway network plan of the city of Washington with correspondingly distorted geographic data from the map shown in FIG. 1A.

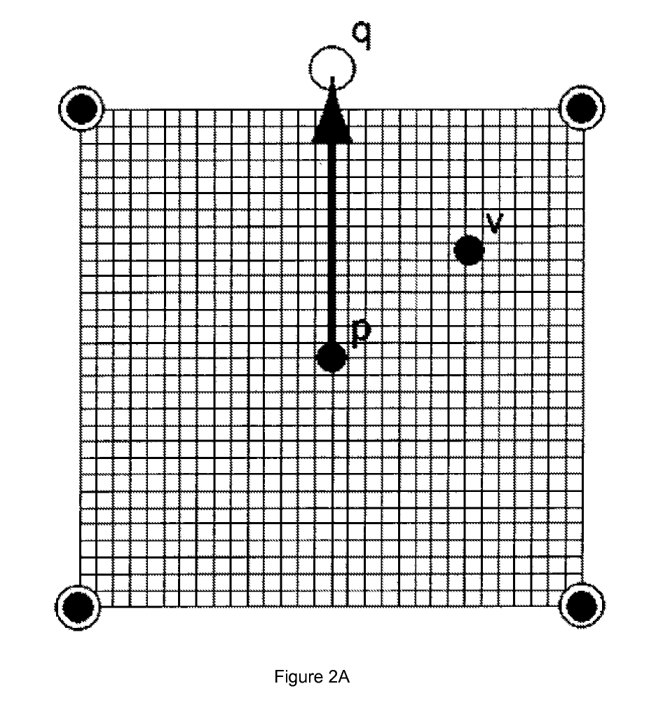

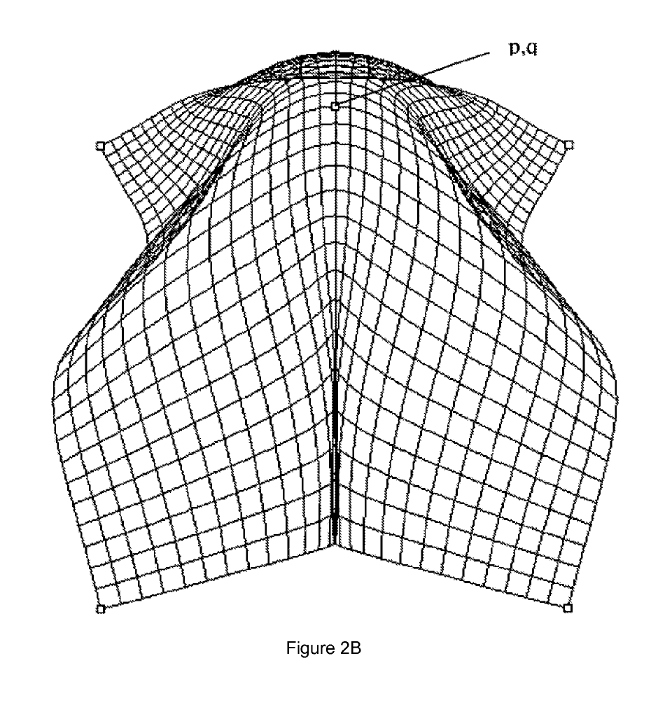

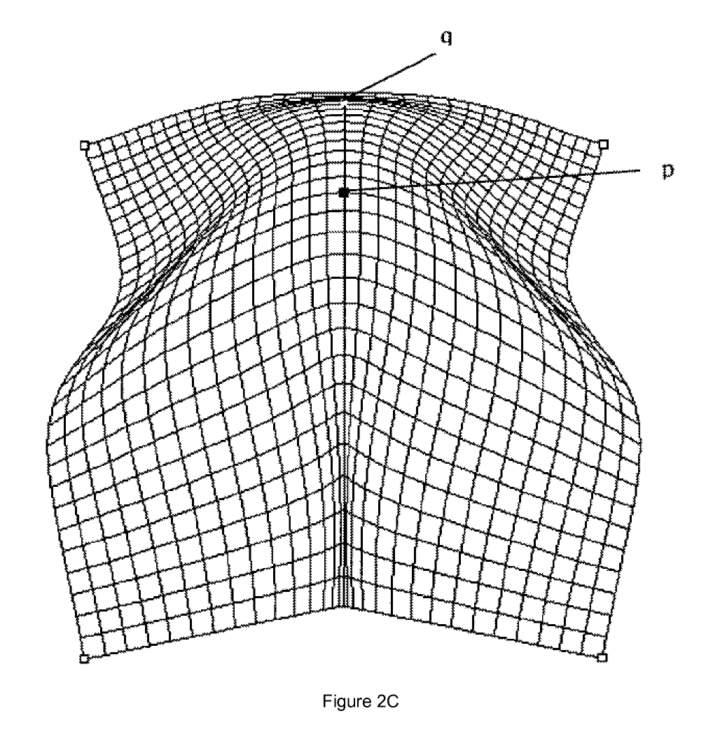

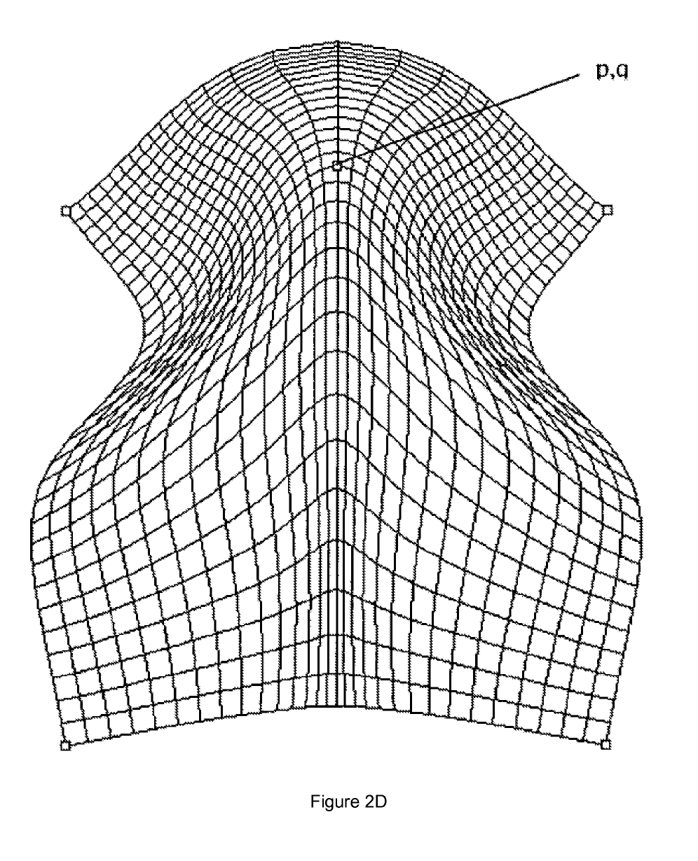

FIG. 2A shows an example of a grid which is not distorted, i.e., deformed and comprises fixed control points.

FIG. 2B shows a 2D map with overlap, which was generated by applying a moving least squares (MLS) method to the example of a grid from FIG. 2A.

FIG. 2C shows another map, created by scaling the map from FIG. 2B.

FIG. 2D shows a map without overlap, generated by iterative application of the mapping functions and concatenations (i.e., linking) of these functions used in FIG. 2B and 2C.

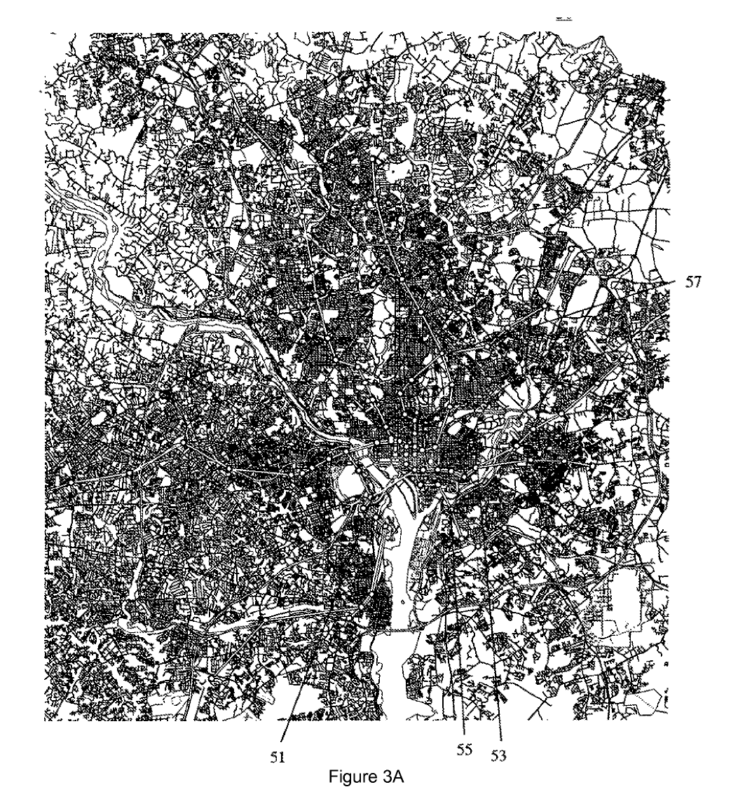

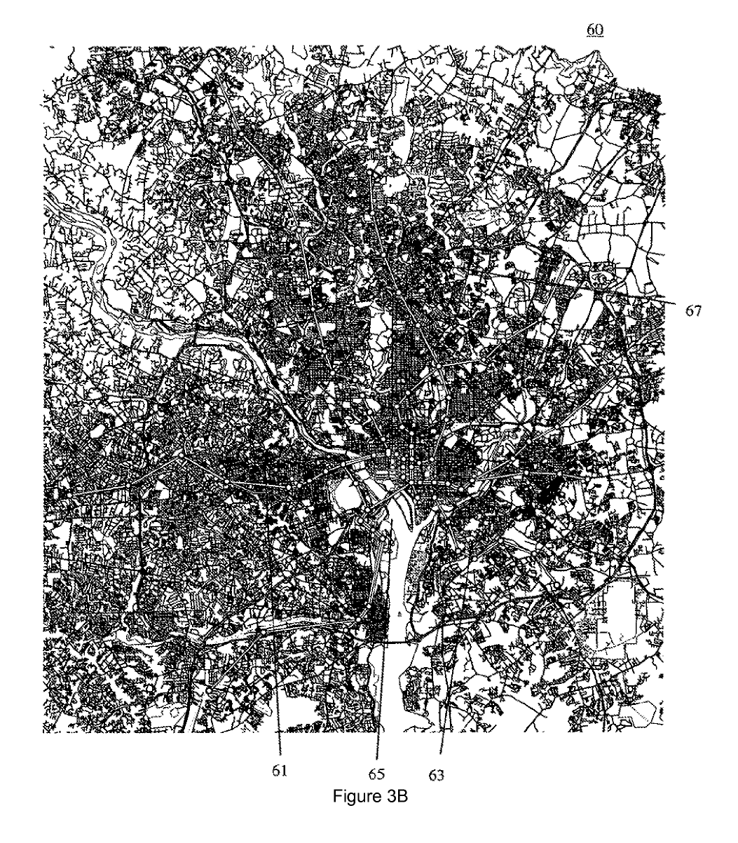

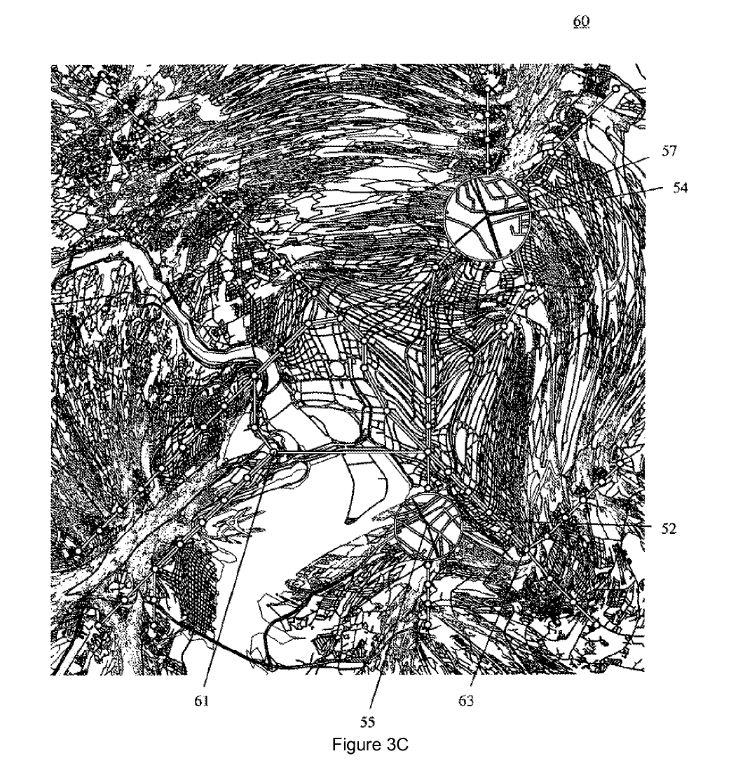

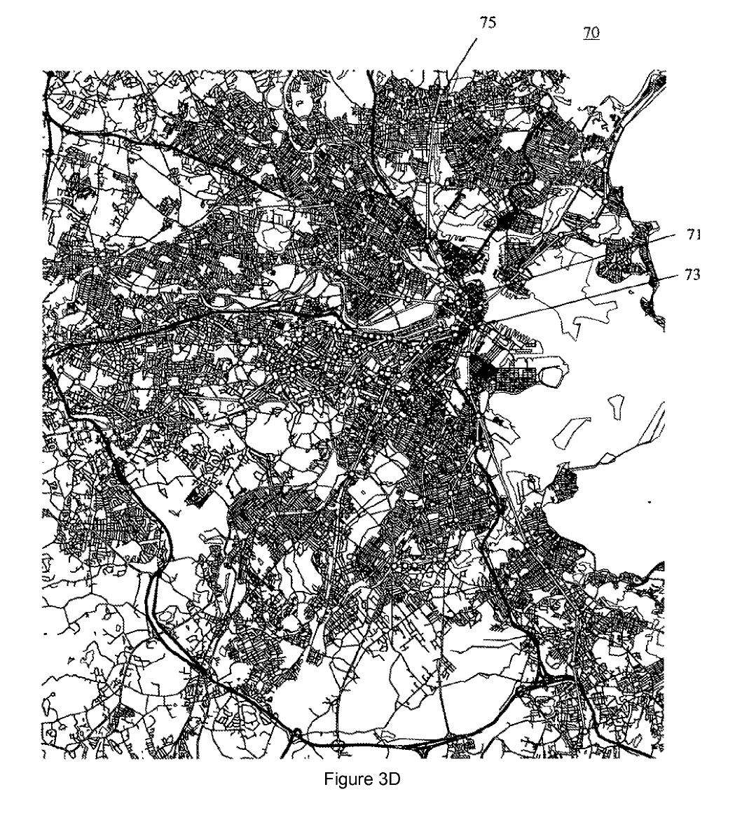

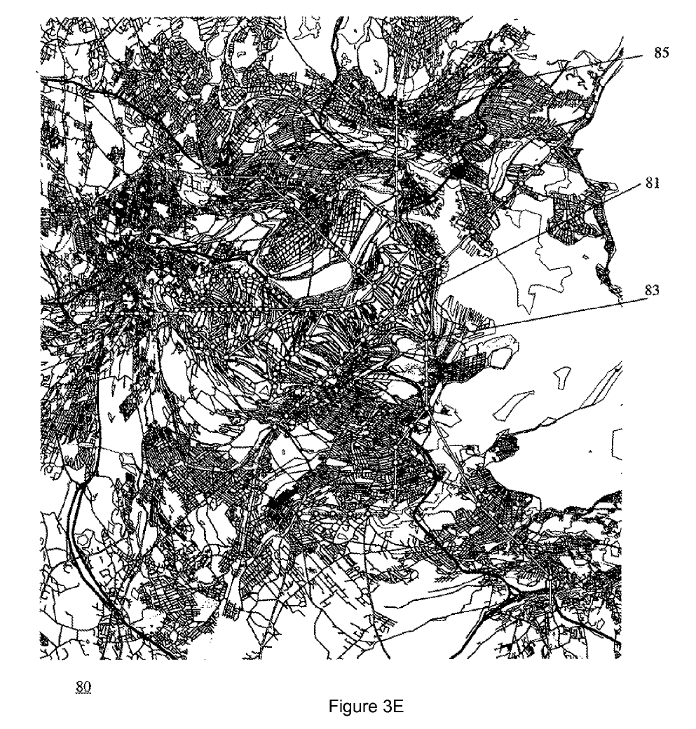

FIG. 3A shows an example of a geographic map of the city of Washington.

FIG. 3B shows an example of a distorted, i.e., deformed geographic map of the city of Washington, which is adapted to a corresponding schematic map.

FIG. 3C shows an example of a distorted, i.e., deformed geographic map of the city of Washington, which is adapted to a corresponding schematic map, in which two details are represented as enlarged by a lens, so the geographic map is shown as rectified and the schematic map is shown as distorted.

FIG. 3D shows an example of a geographic map of the city of Boston.

FIG. 3E shows an example of a distorted, i.e., deformed geographic map of the city of Boston, which is adapted to a corresponding schematic map.

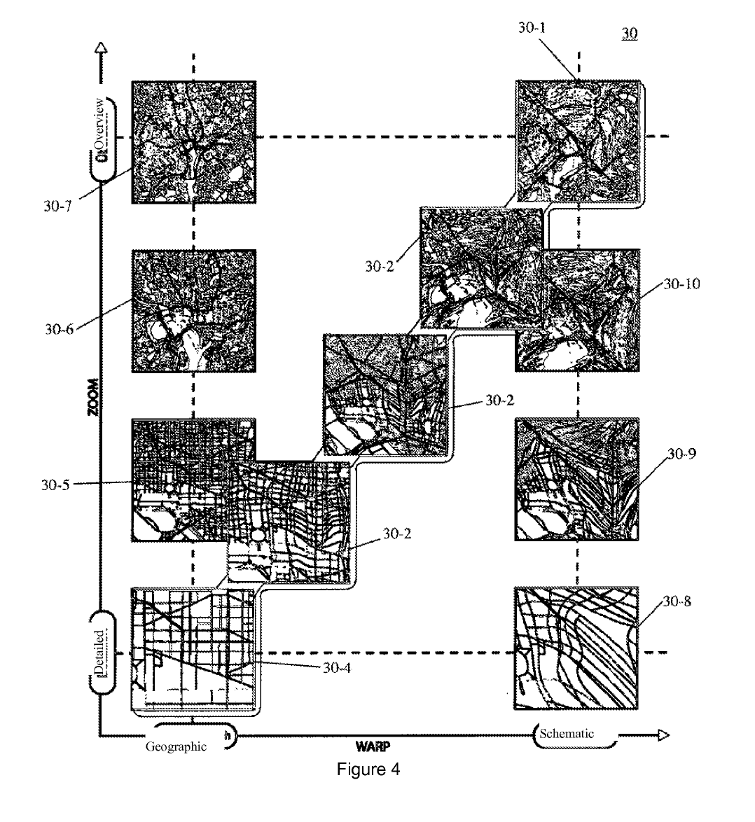

FIG. 4 shows an exemplary application of a warping zoom between the schematic map and a (corresponding) geographic map.

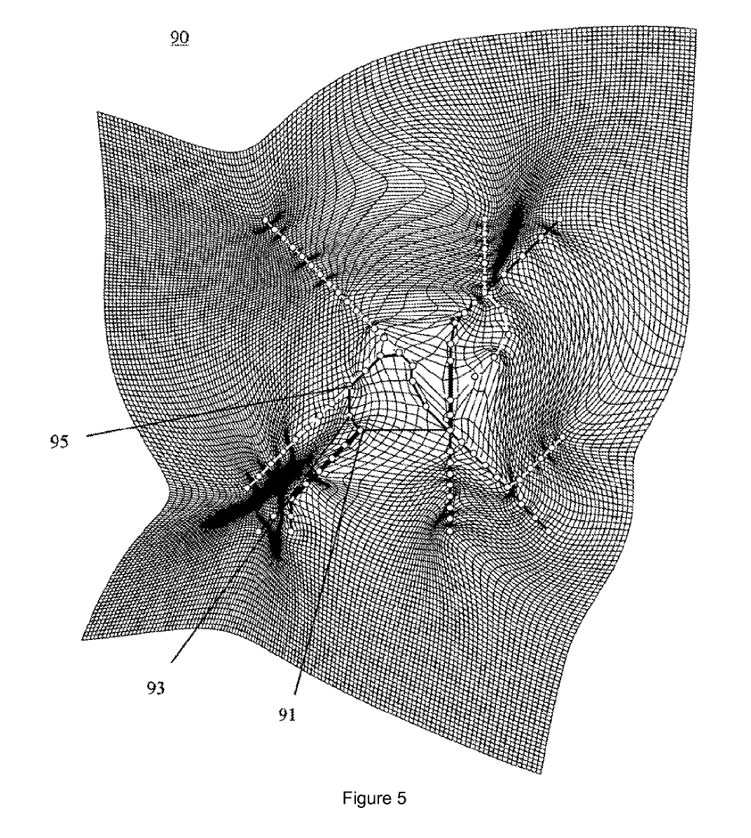

FIG. 5 shows a distortion and/or deformation of a regular grid.

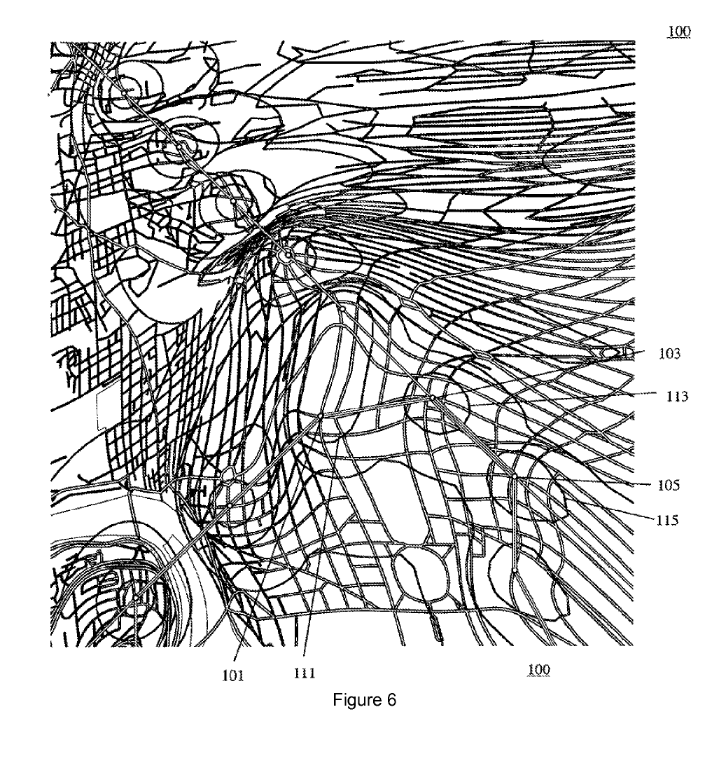

FIG. 6 shows an annotated schematic map, which additionally comprises isolines.

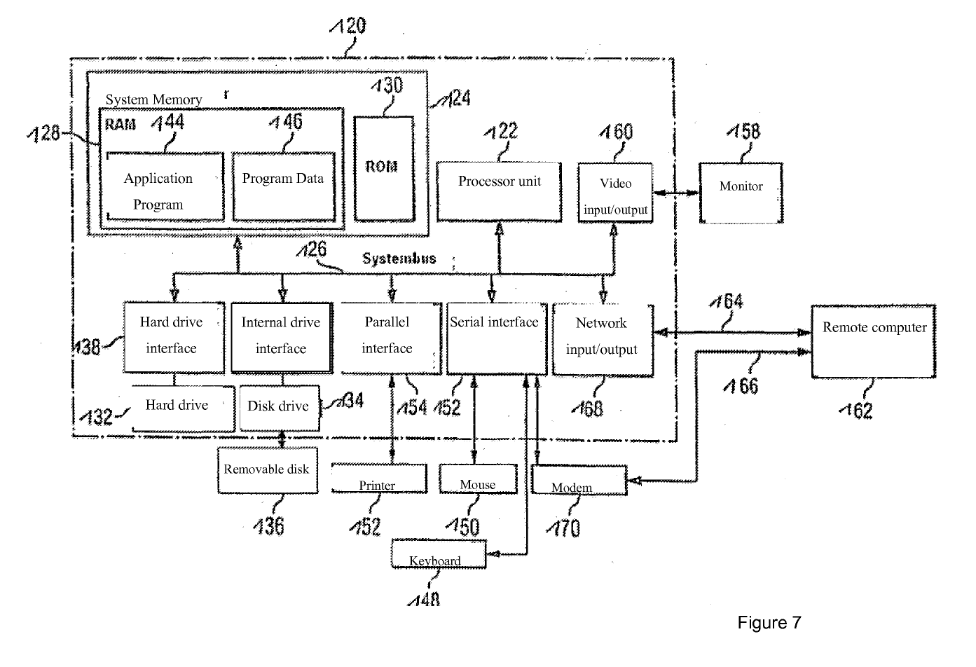

FIG. 7 shows a blocking diagram of a technical design of a computer and a (computer) network.

The following terms are used in the present description and are defined essentially as follows:

Geographic Map (Representations):

Geographic maps and/or map representations comprise, for example, city maps, state maps and road maps such as those used in navigation systems in particular for (small) mobile terminals (e.g., PDAs, cellular telephones). Such geographic maps have the least possible distortion (and/or deformation) and/or are compressed or stretched, i.e., they map the real world geometrically in a much smaller scale (essentially) as accurately as possible, in particular with respect to the technical properties of the display and/or a representation means used) so that, for example, streets and rivers have the same curvature as in the real world. Although annotations such as the width of a street or the building of a subway station are normally distorted, distances and angles between such geographic and/or cartographic entities still correspond to those in the real world. For example, if a road in the real world is 3.76 km long, it will have a correspondingly accurate length in the reduced scale of a geographic map. Geographic maps comprise an abundance of detail information (e.g., road networks, position marks, generally known as “landmarks,” public buildings and facilities, topographic properties, rivers, lakes, etc.). Accordingly, the geographic maps represent and/or map details from the real world.

Schematic Map (Representations) and/or Plans or Network Plans:

Schematic maps and/or network plans (e.g., plans of a public transportation system of a city, rail lines, signal box plans, plans for high-voltage lines and transformer stations, plans for water lines and sewer lines) and/or schematic map representations show clearly and in simplified form, i.e., schematically the information that is necessary and/or advantageous only for the corresponding network, e.g., points and connecting lines of different colors between the points, where the points represent stops in a transportation system, for example, and the lines of different colors represent different subway lines, streetcar lines, tram lines and/or bus lines. Unlike geographic maps, in a schematic map there is not, as a rule, a complete representation of the physical and geographic environment and/or surroundings. Accordingly, schematic maps represent only individual aspects of the real world. These aspects relate to the thematic content (e.g., subway stations and lines) as well as to the arrangement of such cartographic entities (such as exclusively straight connecting lines or maintaining the relationship “north of” but not “northeast of”). The arrangement of the cartographic entities usually cannot be described with cartographic rules because this is no longer a uniform map, but instead different principles are intermingled. In particular distances, relationships, courses of roads and angles usually (at least partially) no longer correspond to those in the real world. Schematic maps may be either produced or generated manually or electronically.

With reference to FIGS. 1A-1C, a computer-implemented method and system and a corresponding computer program product as well as a display are described on the basis of a geographic map 10 and a schematic map 20, superimposing and/or supplementing and/or annotating (dynamically) the schematic map and/or map representation 20 with geographic data of the corresponding geographic map and/or map representation 10 to obtain a corresponding geographically annotated schematic map and/or integrated map and/or map representation 30 (interactively and/or situationally integrated and/or depending on the situation and/or depending on the state), i.e., a schematic map supplemented with geographic data. In particular in the case of an integrated map 30, the schematic character of the schematic map 20 is preserved and/or integrated. Accordingly, the schematic map 20 is not adapted to the geographic map 10, but instead the geographic map 10 is distorted to be adapted to the schematic map 20. Distortion of the geographic maps 10 comprises a computer-implemented deforming, distorting, compressing and/or stretching of (two-dimensional) geographic data, so that the data no longer represents a map of a detail of the real world. Image warping techniques are preferably implemented for distorting the geographic map 10, in particular in combination with techniques for preventing overlapping and warping.

Both the schematic map 20 and the geographic map 10 are in electric, i.e., electronic form and can be displayed on a display screen of a (mobile) terminal (e.g., computer, notebook, mobile telephone, PDA). The schematic map 20 with corresponding geographic data are annotated by adaptation and/or distortion of the geographic map 10 using a suitable image warping technique (image and/or graphic deformation and/or distortion). Image warping in the field of computer graphics belongs to the image-based techniques applied to the schematic map 20. For example, if there is a respective depth value for an electronic image, it is possible by means of warping to modify the image so that it can be viewed from a different viewpoint.

Whereas schematic maps 20 are suitable for schematically, i.e., abstractly representing cartographic entities 21-29, such as information about connections 22, 24, 26, 28 and terminals 21, 23, 25, 27, 29, in a public transportation system, they do not comprise any geographically correct information (i.e., corresponding to the real world) about such cartographic entities 21-29 and contain little or no information about geographically correct details such as roads and intersections, which describe the (real) surroundings of a subway station on a reduced scale. An important property of a schematic map 20 is that distances between points 21, 23, 25, 27, 29 (e.g., subway stations) do not correspond to the real geographic distances, for example. To enrich such a schematic map 20 with corresponding geographic data of a geographic map 10, the geographic map 10 is distorted, compressed and/or stretched by means of warping techniques.

In other words, to eliminate the aforementioned disadvantages of a schematic map 20, it is annotated with a suitably distorted geographic map 10. Accordingly, a geographically annotated schematic map and/or integrated map 30 is obtained, which integrates, i.e., combines the properties of a schematic map 20 as well as the properties of a corresponding geographic map 10, so that both schematic map data and geographic map data can be calculated and queried easily and in a user-friendly manner and/or dynamically (i.e., situationally) by means of such an integrated map 30 by using automatic position determination (for example, by GPS, cell determination of a mobile telephone or the like) via a (mobile) terminal that is used (mobile telephone, PDA). Consequently, two navigation levels and/or spaces, which describe a geographic area such as a city by means of various aspects (e.g., subway trips, walking by foot from a subway station to a museum), are connected automatically in a dynamic manner.

In the integrated map 30 in particular, not only is a geographic map 10 superimposed on a schematic map 20, but instead at least parts and/or elements of the two maps remain (side by side) in the integrated map and are also visible even with any selected degree of distortion, which can be selected between a purely geographic map representation and a purely schematic map representation and are shown on a display. In other words, unlike a pure crossfade of two map representations, in which a purely schematic representation displays only the schematic map 20 and in which a purely geographic representation displays only the geographic map 10, both maps are visible in these two extreme cases of distortion. Consequently, the integrated map 30 merges the two maps into one, so that a continuous (preferably essentially linear), interpolating and thus also bidirectional mapping of the two maps 10, 20 dynamically into one another in the integrated map 30 is achieved by using a distortion algorithm (in particular warping with overlap control).

Vector data and/or metainformation, describing the corresponding geographic region (e.g., a city area), is preferably used as the basis for generating the integrated map 30 and is available in particular in a markup language (possible examples include US Census TIGER Data Format, OSM Data, XML or similar formats and/or a combination thereof. The vector data and/or metainformation may have information and/or points corresponding to bordering points of roads, buildings, parks and/or bodies of water and/or subway stations. For at least a portion, preferably essentially all the elements and/or points, their geographic position (corresponding to the position in the geographic map 10) is stored in a database. In addition to this point data, connecting information is advantageously also present, indicating which points are connected to one another (e.g., roadway systems, polygon outlines, connecting lines between subway stations). In addition, type designations for streets and polylines may also be included (as metainformation). Such a data set can already be represented and/or drawn as a geographic map (e.g., as a road map).

The preferred use of vector data (e.g., XML, USA Census TIGER data, OpenStreetMap OSM or the like) offers advantages here in comparison with pixel data (jpg, gif, png or the like), in particular with regard to a situational adaptation of the map and/or map representation.

One advantage may consist of the fact that data in the form of vector data can be plotted and/or represented with any resolution. If the representation and/or viewing parameters are modified (e.g., enlargement factor/reduction factor and/or displacement factor, for example, due to the user's interactive use of the mouse and/or situationally, e.g., as a function of the position determined by GPS), the position data can be transformed on the basis of these parameters (i.e., the positions of the points and thus also the distances between them can be recalculated). The next time the image is refreshed, the points of the database may be plotted and/or represented together with their connecting lines at their newly calculated positions. Therefore, the resulting representation is more easily calculable and also allows and/or facilitates in particular their calculation by less powerful processes.

Another advantage may consist of the fact that details can be faded in or out (i.e., the so-called level of detail can be varied). The vector data can be filtered, i.e., it is possible to determine in a targeted manner which streets and/or locations of which type are to be displayed. For example, it is possible to determine beyond which reduction factor only highways, bodies of water and parks are to be plotted, i.e., represented.

For the creation of the integrated map 30 (preferably dynamically interactive and/or situationally variable, in particular with integrated warping zoom), the data set described above can be supplemented to the extent that an alternative position is stored and/or calculated for points on and/or elements of the schematic map 20 (e.g., for each subway station) (so-called “schematic position”) which corresponds to the position of the element in the schematic map 20. If the elements (e.g., the subway stations) at their “schematic” positions (preferably together with their connecting lines) [sic], this yields the schematic map 20, e.g., a layout of the subway system that is geographically incorrect but is easy to read.

The resulting map to be calculated (integrated map 30) may be created and/or calculated from the database and its continuously adaptable graphic representation (in particular taking into account viewing parameters, level of detail and/or layout). Relevant viewing parameters here may include an enlargement factor and/or a reduction factor and/or a translational vector and/or a displacement vector, so that by changing the viewing parameters, it is possible to focus the user on situationally relevant content, thus resulting in better readability for the user and/or an improved user/machine inter-face and interaction. Furthermore, viewing parameters may be interactively and/or situationally controllable. Furthermore, a selective representation of situationally relevant locations and/or location relationships is also possible, so that the level of detail can be controllable interactively/situationally. In addition, a readable layout of the situationally relevant location relationship is advantageously possible, so that the layout can be controllable interactively/situationally.

Thus, in a preprocessing step (i.e., regardless of the running time), the database may be supplemented in such a form that two positions exist and are stored for at least some (preferably essentially all) of the relevant points and/or the points to be represented (e.g., of all subway stations) in the database, namely one position corresponding to the geographic map 10 and one position corresponding to the schematic map 20. In particular, two positions (geographic and “schematic” positions) are already stored for the subway stations in the “original” database, but the other points at first usually have only a geographic position (i.e., a position in the geographic map 10). In this regard, the missing “schematic” positions (i.e., positions in the schematic map 20) of at least some, but preferably essentially all the remaining points may also be stored in the database by applying a warping method (in particular the warping method described in greater detail below). Accordingly, two positions (i.e., a geographic position and a “schematic” position) may be saved in the database (in particular after the preprocessing step) for the corresponding points (in particular all points). If the points are represented and/or displayed in their geographic positions (in particular together with their connections), then the information required by the user, e.g., situationally as a pedestrian, is laid out so that it is more easily readable and/or comprehensible for this situation. However, if the points are represented and/or displayed at their “schematic” positions (in particular together with their connections), then the information required by the user, e.g., situationally as a subway rider, is laid out so that it is more readily readable and/or understandable for this situation.

One advantage of this method may be seen in the fact that it allows a linear interpolation between the schematic and geographic positions of the points without resulting in overlaps. New positions for the points can be calculated through this linear interpolation between the two positions of each point on the geographic map 10 and the schematic map 20 (and/or on the integrated map 30). The weighting of the two starting positions for the interpolation can be controlled interactively and/or situationally. If the points are plotted at the newly calculated positions, this yields a new map layout. The resulting interactive map 30 can thus be implemented easily on low-resolution mobile terminals because the complex calculation of the schematic positions has preferably already been performed in the preprocessing step. Then on a mobile terminal, only a linear interpolation between the two positions stored previously need be performed in running time.

A computer-implemented method, which is preferably implemented for such a superpositioning of different maps to obtain an integrated map 30, combines an image deformation method, which is preferably based on moving least squares (displacement of the smallest, i.e., least squares) with a method for overlap control in image warping. In this way a readable schematic map 20 (e.g., network plan of a public transportation system of a city, rail line plan, signal box plan, plans for high voltage lines and transformer plants, plans for water lines and sewer lines, for example) is created, comprising additional geographic data (e.g., roads, rivers, parking places, public buildings) from a corresponding geographic map 10 without the schematic representation of the schematic map 20 being influenced, i.e., altered. The geographic map 10 was distorted accordingly.

In other words, the geographic map 10 is adapted by means of interactive and/or dynamic (and/or situationally) distortion (preferably image warping techniques) to the schematic map 20. In addition, in this interactive extrapolation to create an integrated map 30, a zoom mechanism is combined, i.e., linked with an image warping technique which comprises overlap control—in particular as described—namely, preferably by way of a user-definable level of detail which depends on map data and/or geographic position. The geographic position is calculated, i.e., determined automatically by means of GPS, for example. The map 30 integrated in this way makes it possible for a user to display comprehensive map data with more or less geographic detail information on a (mobile) terminal.

By connecting, i.e., linking the functions of distortion, a semantic level of detail (i.e., by choice) and/or a geometric level of detail (i.e., by resolution) and/or an enlargement of a detail, an integrated map representation can be optimally adapted automatically as a function of a geographic position and/or a speed of movement to certain geographic factors, (navigation) requirements and/or capacities of a user's output device (size of the display, memory, range, resolution).

Thus, the layout and/or the display in particular (i.e., the map 30 to be represented) can be adapted to the user's situation in running time, so that the situational parameters may be the viewing parameters (enlargement/reduction and/or shift factor), the so-called level of detail and geographic and/or schematic representation (and/or layout). Due to the fact that vector data are advantageously used as the database, the control of the viewing parameters and/or the level of detail can be achieved unproblematically. Furthermore, the adaptation of the layout (i.e., the integrated map 30) can also be calculated easily as described above, wherein it is a special advantage that a simple coupling of these situational parameters and their simultaneous control is made possible. Thus a situationally applied layout adaptation (i.e., a modification of the integrated map 30) is achieved by coupling the (preferably linear) interpolation (i.e., transformation of the database) and the change in the viewing parameters (scaling factor, displacement) and/or the content selection (level of detail). This is all the more advantageous, because as a rule, a situation which requires an overview map at the same time provides less space for displaying all the details. Furthermore, there are applications and/or situations in which a completely different information content (e.g., a transportation system) is of interest in the overview mode. This circumstance may be taken into account in the representation described here to the extent that the representation of the combined database can be adapted to the extent that the relevant information is more easily readable (so-called “warping zoom”), wherein the adaptation can be controlled interactively by the user and/or automatically. In automatic control, the layout and/or viewing parameters can be derived, e.g., from the speed, acceleration, position and/or orientation of the user.

Consequently, in warping coupled with zooming (warping zoom), an integrated map 30 can be warped and/or distorted less, the greater the zooming of the integrated map 30 (i.e., enlargement).

Accordingly, an integrated map 30 is created, comprising both schematic data from cartographic entities such as points and connecting lines as well as the respective and/or corresponding geographic data, for example, detailed road information, public buildings, parking places, etc. The integrated map 30 is created by applying warping techniques to a geographic map 10, so that this geographic map 10 is adapted to a schematic map 20 by distortion. The respective parts and/or elements (e.g., certain cartographic entities) of both maps are contained and/or displayed even in “extreme positions” (i.e., in both a purely schematic representation and in a purely geographic representation of the integrated map 30). For such a distortion, a mapping function, i.e., a map from the field of electronic, i.e., computer-supported image distortion (in particular warping) which is suitable for mapping geographic data in particular is used. In addition, a warping zoom may be implemented for such an integrated map 30, which allows a dynamic interactive map representation of geographic and schematic data together, which is suitable for navigation on a geographic detail level (e.g., roads) as well as in network plans (e.g., a public transportation plan).

For automatic connection and/or merger of a schematic map 20 with a geographic map 10 in an integrated map 30, the starting positions, i.e., starting points 11, 13, 15, 17, 19 in the geographic map 10 and (corresponding) destination positions, i.e., destination points 21, 23, 25, 27, 29 in the schematic map 20 of corresponding cartographic entities (for example, subway stations, railway stations, filling stations, signal boxes, transformer plants, sewer outlets) are preferably used as control points for a warping algorithm with overlap control. The data of both maps 10, 20 are therefore preferably in electronic, i.e., computer-supported form, so that they can be processed easily by computer.

Accordingly, the map data of both maps 10, 20 are stored in a memory device (e.g., database). The map data have been determined and/or detected manually and/or automatically in advance.

Destination positions 21, 23, 25, 27, 29 of a schematic map 20 are, for example, points in a network plan, such as subway stations and/or other stopping points of a public transportation system in a network plan of a public transportation system of a city. Starting positions 11, 13, 15, 17, 19 in a corresponding map 10 are the geographic entities, e.g., subway stations and/or other stopping points of a public transportation system corresponding to the destination positions 21, 23, 25, 27, 29, such as those shown in a city map (geographically correct).

More precisely, corresponding positions 21, 23, 25, 27, 29, 11, 13, 15, 17, 19 in the two different map formats 20, 10 are used as control points in an automatic method, in particular a warping technique from the field of image warping, in which the positions 11, 13, 15, 17, 19 in the geographic map 10 are used as starting positions 11, 13, 15, 17, 19, and the positions 21, 23, 25, 27, 29 in the schematic map 20 are used as destination positions in the (automatic) warping method for calculating a map and/or a mapping function of the geographic map 10 on the schematic map 20. The mapping or mapping functions, applied to the geographic map 10, displaces the geographically correct starting positions 11, 13, 15, 17, 19 to their corresponding destination positions 21, 23, 25, 27, 29 and distributes (at least a portion of) the remaining geographic detail information of the geographic map 10 between these positions 21, 23, 25, 27, 29 displaced in this way, uniformly accordingly (in particular continuously).

For the interactive integration of a schematic map 20 with a geographic map 10, warping methods from the field of computer-supported image warping are preferably used. Most warping methods fundamentally perform calculations as follows: starting from two-dimensional information (e.g., image data) and a set of control points in this information, a mapping function is calculated, continuously mapping these (discrete) control points (e.g., subway stations 11, 13, 15, 17, 19 in FIG. 1A) from their corresponding starting positions onto any selected destination positions. The mapping function then preferably has one or more of the following properties:
(1) The mapping function interpolates, i.e., the starting positions of the control points are mapped (exactly, i.e., precisely) on their corresponding destination positions, so that the mapping function describes a continuous map of the discrete control points.
(2) The mapping is seamless, i.e., uniform, i.e., there are no discontinuities (i.e., jumps or gaps) between the control points. In other words, the mapping function is continuous.
(3) The mapping does not contain any overlaps.

Properties (1) and (2) thus specify that a (continuous) interpolant is calculated for the (discrete) control points, i.e., a continuous function which maps the starting positions (exactly) on the destination positions. Consequently, the mapping function is bidirectional, i.e., applicable to a geographic map and a schematic map representation with any degree of distortion. Consequently, an integrated map representation 30 may be distorted (warped) in both directions (geographically and schematically).

In one implementation, a warping method which comprises scattered data interpolation and generates a continuously interpolating mapping function is used. Furthermore, the angles in a distorted map remain as similar to corresponding angles in a geographically correct map as possible, so that a form, i.e., shape of the corresponding real cartographic entities (i.e., the information and/or elements contained in the geographic map 10, remains recognizable. In particular a warping method is implemented accordingly, based on a displacement of least possible squares (a so-called “moving least squares” method), interpolating a similarity transformation between corresponding starting positions and destination positions of control points such as, for example, the starting positions 11, 13, 15, 17, 19 of the geographic map 10 and the corresponding destination positions 21, 23, 25, 27, 29 of the schematic map 20, which specify cartographic entities (i.e., of the information, i.e., elements contained in the geographic map 10), in particular subway stations as control points.

If a moving least squares method in particular is used, then angles are distorted less than when a general affine transformation is interpolated. Since a map calculated using this method comprises overlaps in two-dimensional data with a corresponding distortion, this moving least squares method is combined with a method for control of overlaps in image warping (a so-called overlap control and/or overlap avoidance method), because unlike analysis and representation of image data distortions, avoidance of overlaps in distortion of geographic data and/or information is advantageous because otherwise parts of the data would disappear and would no longer be visible in a distorted representation.

Consequently, a representation of a map 30 integrated in this form is better, i.e., more understandable for a user and can be represented independently of certain technical parameters of the output device that is used.

With reference to FIGS. 2A to 2D, a possible implementation of a warping method is described for interactive integration of geographic map data into schematic map data using a combination of a moving least squares (MLS) method with overlap control, i.e., overlap avoidance for image warping. In one implementation, the control points are cartographic entities (e.g., subway stations), where the starting positions are the real positions (i.e., geographically correct positions, e.g., positions 11, 13, 15, 17, 19 in FIG. 1A) of the cartographic entities in a geographic map 10 (e.g., a map of this city) and the destination positions are the corresponding points for the cartographic entities in a schematic map 20 of the public transportation system of this city (e.g., positions 21, 23, 25, 27, 29 in FIG. 1B).

(1) Moving Least Squares

For one or more starting positions p, their corresponding destination positions q and any point v, an optimal affine transformation Iᵥ(x) is calculated, wherein the following sum is minimized:

$${\sum }_{i} {w}_{i} {\vert {l}_{v} ( {p}_{i} ) - {q}_{i} \vert}^{2} .$$

This method is known as “moving least squares minimization” because the weights éᵢ depend on the point v:

$${w}_{i} = \frac{1}{{\vert {p}_{i} - v \vert}^{2 a}}$$

The parameter á here controls a decay profile for the distance between the starting positions ρ and the point v and is preferably greater than 1. In a preferred implementation, an experimental value of 1.5 was selected for α.

Accordingly, such a calculation yields a separate (perhaps different) affine transformation Iᵥ(x) by displacement of the least squares in a grid for each individual point v. If the allowed transformations becomes similarity transformations, this yields the following (optimal) mapping function for the individual points v:

$${l}_{v} ( x ) = ( x - {p}_{*} ) \frac{1}{{μ}_{s}} {\sum }_{i} {w}_{i} ( \begin{matrix}{β}_{i} \\ - {β}_{i}^{⊥}\end{matrix} ) ( {\hat{q}}_{i}^{T} - {\hat{q}}_{i}^{⊥ T} ) + {q}_{*}$$

wherein p* and q* denote the following weighted centroids:

$${p}_{*} = \frac{{\sum }_{i} {w}_{i} {p}_{i}}{{\sum }_{i} {w}_{i}}$$

$${q}_{*} = \frac{{\sum }_{i} {w}_{i} {q}_{i}}{{\sum }_{i} {w}_{i}}$$

Furthermore, the following equations hold for the definitions introduced above:

pᵢ=\hat{p}ᵢ−p*,\hat{q}ᵢ=qᵢ−q*,μₛ=Σᵢ wᵢ \hat{p}ᵢ \hat{p}ᵢ^{T}

where T is an operator which maps a vector (x, y) on (−y, x).

In one implementation, these mapping functions for individual points are applied individually to control points in a geographic data set (for example, a geographic map 10).

FIGS. 2A and 2B show a simple example of an application of the mapping function introduced previously. FIG. 2A shows a 2D mapping function which results from the definitions introduced previously and is applied to a regular grid. In FIG. 2B overlapping parts of the resulting 2D mapping function are shown after application to the regular grid from FIG. 2A.

(2) Overlap Control (Overlap Avoidance)

With reference to FIGS. 2C and 2D, a method is described whereby the overlaps resulting from the 2D mapping function obtained previously can be avoided. One aspect of the overlap preventing mapping function is that another mapping function, which is obtained by scaling the map, i.e., by interpolation with the identical transformation, can be derived for each given mapping function (in particular the mapping function described previously with respect to FIGS. 2A and 2B, which is based on a moving least squares method). Such a scaling using a scaling factor s (in particular for warping geographic map data) yields the following mapping function:

lₛ(v,s)=(1−s)v+slᵥ(v)

Another aspect of such an overlap-preventing mapping function (and method) is that overlaps occur at each point in a given mapping function (in particular the mapping function described previously with respect to FIGS. 2A and 2B, which is based on a moving least squares method) in particular when the Jacobian determinant changes the plus or minus sign (i.e., from + to − or vice-versa). Consequently, it is advantageous to limit this determinant J, so that it is at least positive. Since values of the determinant J are closer to 0, this means that the mapping at this location (and/or point and/or least square) compresses the data and/or information that has been distorted by warping to an especially great extent. The determinant J in particular is limited further and is subject to additional boundary conditions. The determinant J is in particular greater than a minimum Jₘᵢₙ.

The determinant J may consequently be calculated by calculating or making estimates of the partial derivation of two points closer to a point v, as shown below:

$$( \frac{\partial f}{\partial x} , \frac{\partial g}{\partial x} ) \approx \frac{{l}_{v} ( v ) - {l}_{v} ( v + ( δ , 0 ) )}{δ}$$

$$( \frac{\partial f}{\partial y} , \frac{\partial g}{\partial y} ) \approx \frac{{l}_{v} ( v ) - {l}_{v} ( v + ( δ , 0 ) )}{δ}$$

$$J = \frac{\partial f}{\partial x} \frac{\partial g}{\partial y} - \frac{\partial f}{\partial y} \frac{\partial g}{\partial x}$$

In this estimation, a is any small value. Then it is guaranteed, i.e., ensured (essentially) for a plurality of scaling values s, where 0<s<1, that a mapping function derived from these calculations does not contain or create any overlaps.

To find and/or determine an ideal scaling factor s (as ideal as possible), the following quadratic equation is used:

$$J = ( ( s \frac{\partial f}{\partial x} + 1 ) ( s \frac{\partial g}{\partial y} ) + 1 ) - {s}^{2} \frac{\partial f}{\partial y} \frac{\partial g}{\partial x} = {J}_{min}$$

In other words, the Jacobian determinant J should be equal to the minimum Jₘᵢₙ defined previously.

In solving a quadratic equation, between 0 and 2 intersection points (i.e., roots), are obtained. Since the Jacobian determinant J always yields 1 at a scaling factor of s=0, and is smaller than the minimum Jₘᵢₙ only at the intersection points, the mapping function is free of overlaps locally or is greatly compressed for all scaling factors greater than 0 but is less than or equal to the smallest intersection in the interval between 0 and 1. Accordingly, to obtain an essentially rapid convergence of the Jacobian determinant J at the minimum Jₘᵢₙ, this intersection (and/or root) becomes the scaling factor for the method for preventing overlaps in the mapping function based on warping. If no such intersection exists, then 1 is preferably used as the scaling factor.

To determine in particular a global (essentially) optimal scaling factor, the equation for the Jacobian determinant J, which was introduced previously would have to be calculated for all points used in the mapping function defined with respect to FIGS. 2A and 2B. However, since such a calculation is not possible for all points (because there are an infinite number of such points), the equation for the Jacobian determinant J is solved only for discrete points, i.e., positions in a grid. In particular the equation for the Jacobian determinant J is calculated for all (control) points (if possible), which are mapped individually by means of the mapping function with respect to FIGS. 2A and 2B. Consequently, the global (almost) optimal scaling factor is then the minimum of the locally optimal scaling factors for each of the points mapped individually.

Now if the entire 2D mapping function (which is based in particular on the moving least squares method) is scaled using the scaling factor calculated in this way, this yields a new map (and/or mapping function), which still does not fulfill the properties (1), (2) and (3) in particular but nevertheless brings the control points closer to their destination positions, as shown in FIG. 2C.

If the process illustrated in FIG. 2C is not iterated, i.e., repeated, and these partial maps obtained in this way are concatenated, i.e., linked, then the control points will converge somewhere close to their destination positions. One disadvantage with such a procedure is that such a convergence is not ensured for all cases. If the minimum Jₘᵢₙ is selected to be too small, this leads to an unnecessarily great compression. However, if the minimum Jₘᵢₙ is selected to be too large, a (relatively) rapid convergence is prevented. Accordingly, a minimum Jₘᵢₙ=0.5 is preferably selected. With such a value for the minimum, overlaps in a mapping based on warping for 2D (geographic) data and/or information can be controlled (essentially) reliably and well, with a convergence of the control points at their destination points typically being reached within 5 to 15 iterations of the method described above. One result of such an iteration for the regular grid from FIG. 2A is shown in FIG. 2D.

In a special implementation of a system and method for generating a combined schematic and geographic map, a schematic map 20 of a public transportation system, which is available in electronic form, is used. The schematic map 20 comprises one or more positions and/or control points 21, 23, 25, 27, 29, which describe subway stations, for example, as shown in FIG. 1B.

For geographic information, which is represented in a geographic map 10, US Census TIGER map data may be used. However, other data (i.e., data from other databases and/or data sources) about geographic information may also be used. The data used (e.g., the US Census TIGER map data) in particular comprise computer-based vector data, which maps, i.e., represents detailed street information, position markings, also generally referred to as landmarks, such as public facilities, filling stations, public parks, bodies of water, airports, train stations, etc., for example. Vector data are well suited in particular for representing geographic information in a display of a (mobile) terminal (e.g., cellular telephone, PDA, notebook) because they are scalable. Furthermore, vector data are suitable for transformation of a topography, for example, independently of symbolic markings or text markings, to achieve better readability of data and/or information.

Vector data and/or metainformation describing the municipal area, for example, and available in a markup language (US Census TIGER Data Format, OSM data, XML and/or other similar formats are conceivable) may be used as the basis for the calculations. Bordering points of elements contained therein (e.g., roads, buildings, parks and/or bodies of water) as well as one or more elements of at least one unit to be represented schematically (e.g., points for streetcar and subway stations) are advantageously also included. For at least some or all points, their geographic position is preferably stored i.e., provided in the database. In addition to these point data, connecting information is advantageously also present, indicating which points are interconnected (roads, polygon outlines, connecting lines between subway stations or the like). In addition, type designations for elements (e.g., roads, polylines, etc.) may also be included as metainformation.

In this context, vector data (e.g., XML, US Census TIGER Data Format, OpenStreetMap OSM or combinations thereof) are also advantageous in comparison with pixel data (e.g., jpg, gif, png and the like) because vector data may be represented in any resolution with regard to a situational adaptation of a map in particular, so that in the case of a change in the viewing parameters (in particular enlargement factor/reduction factor and/or displacement factor, e.g., due to user input by interactive use of a mouse, for example), the position data can be transformed on the basis of these parameters, i.e., the positions of the points and thus also the distances between them can be recalculated, so that (e.g., with the next image refresh) the points of the database together with their connecting lines can be represented at their newly calculated positions. Furthermore, details may be faded in or out (i.e., the level of detail can be altered). In this context, the vector data can be filtered, i.e., selected interactively and/or situationally (for example, it is possible to define in a targeted manner which roads and/or locations of which type are to be displayed, so that it is possible to determine, for example, beyond which reduction factor only highways, bodies of water and parks are to be represented). Furthermore, for the creation of the integrated dynamically interactive map in particular (preferably with an integrated warping zoom), the data set described above can be supplemented, e.g., an alternative position (so-called schematic position) can be stored, i.e., provided for each element (e.g., subway station). If the elements (e.g., the subway stations) are shown at their “schematic” positions, in particular together with their connecting lines, this yields a geographically incorrect representation but it is an easily readable representation, i.e., a schematic map 20 (e.g., a layout of a subway network resembling a conventional schematic subway system layout).

Such geographic data which are available in the form of vector data are annotated, i.e., supplemented with data and/or information corresponding to the positions 21, 23, 25, 27, 29 in the schematic map 20, i.e., the geographic positions 11, 13, 15, 17, 19 correspond to the subway stations, for example, as shown in FIG. 1A. Such an annotation may be performed manually or automatically. To do so, the corresponding information may be downloaded and/or inserted from other publically accessible sources such as GoogleMaps. FIG. 1A shows an annotated geographic map 10 having the geographic positions 11, 13, 15, 17, 19 corresponding to the schematic positions 21, 23, 25, 27, 29

Before the geographic map 10 is distorted by means of a warping-based method, which avoids overlaps (in particular the method described above with reference to FIGS. 2A through 2D), long lines are selected to be sufficiently fine and/or thin in the geographic starting data of the map 10, so that artifacts are avoidable in display of the lines and the polygons in between. Furthermore, such a modification, i.e., change in long straight lines is also advantageous because lines are mapped on curves even if the mapping (function) described with respect to FIGS. 2A through 2D is continuous. In particular, mapping of only the starting points and end points of a line and then a straight connection between the two pixels in a distorted map would not lead to the fundamental result of continuously distorted curves. Such a modification of long straight lines in the geographic starting data of map 10 is referred to as subdividing, i.e., parceling. Before applying the warping-based mapping functions with overlap control, i.e., overlap avoidance, a grid having a fixed number of cells is not created by the geographic map 10, nor are the data of the map 10 screened.

In one implementation, the warping-based method with overlap control and/or overlap avoidance is applied to the geographic map 10, as described with respect to FIGS. 2A to 2D. The geographic positions here (and/or starting positions and/or points) 11, 13, 15, 17, 19, which serve as control points in the automatic warping method, are mapped onto the corresponding schematic positions (and/or destination positions and/or target points) 21, 23, 25, 27, 29. As already described, local overlaps are extrapolated for the control points, and these local mapping functions are concatenated. The result is a distorted geographic map 30, which supplements the schematic map 20 by geographic data, so that both data and/or information (parts of elements) of the schematic map 20 and the geographic map 10 are contained in the integrated map 30.

Warping of the geographic map 10 is (relatively) time consuming, i.e., it usually takes up a relatively large amount of computation time and/or computation power. Warping-based mapping is advantageously calculated only once for a set of control points (i.e., only once for a geographic map 10 and a corresponding schematic map 20). The mapped control points of the geographic map 10 are then stored in a memory device (e.g., database).

The distorted geographic data of the geographic map 10 comprising lines and polygons are represented graphically by means of OpenGL and GLUT, for example (e.g., on a display of a PDA and/or portable navigation device). In this way, the distorted map 30 may be displayed interactively. For example, a user can interactively select an image detail on the map 30 with a degree of distortion that is suitable for him by means of a cursor on the display of the integrated map 30 and/or using suitable operating elements (e.g., a scroll bar). As shown in FIG. 1C, the geographic positions of the control points (e.g., subway stations) now have the positions corresponding to the schematic positions 21, 23, 25, 27, 29. Consequently, the warping method, applied to the geographic map 10, wherein certain cartographic entities (for example, subway stations 21, 23, 25, 27, 29 in the schematic map and geographically correctly localized subway stations 11, 13, 15, 17, 19 accordingly in the geographic map 10) serve as control points for the starting positions 11, 13, 15, 17, 19 and corresponding destination positions 21, 23, 25, 27, 29 in the warping method with overlap control, creates a distorted geographic map 30 in which the positions of the control points lie on those of the destination positions 21, 23, 25, 27, 29. In other words, the warping method creates a combination map 30 comprising geographically distorted topological and topographic information, so that the schematic map 10 is enriched, i.e., annotated with distorted, i.e., deformed geographic data of the geographic map 20, i.e., yielding a geographically annotated schematic map 30 comprising cartographic entities of both maps 10, 20.

Due to the fact that the geographic map 10 is distorted i.e., deformed by means of the warping method applied to starting positions and destination positions 11, 13, 15, 17, 19 and 21, 23, 25, 27, 29, a dynamic and/or interactive interpolation (preferably' essentially linear) of the mapping between a geographic map 10 (preferably as accurate as possible) and a geographic map 30 distorted according onto a schematic map 20 as far as the schematic map 20 is itself made possible. In other words, a dynamic interpolation between geographic information and its schematization is supported. Accordingly, a compromise between geography and schematics is obtained from the placement in a convex and/or comprehensive combination of geographic positions 11, 13, 15, 17, 19 and their corresponding destination positions 21, 23, 25, 27, 29 in a schematic map 20. Such a compromise allows a better comprehensibility of both maps 10, 20 together for the user. By means of the preferably linear interpolation between the schematic and geographic positions of the points, namely without overlaps, new positions for the points and/or elements can be calculated between the two positions (geographic position and schematic position) of each point and/or each element. The weighting of the two starting positions can be controlled and/or adjusted interactively for the interpolation. By representing the points in the newly calculated positions, this yields a new map layout (interactive map 30). The possibility of linear interpolation is especially advantageous here because the resulting interactive map can be implemented on low-resolution mobile terminals. Since the complex calculation of the schematic positions may already be performed in the preliminary processing step, only a (linear) interpolation between the two positions stored previously is performed on a mobile terminal in running time.

Accordingly, a sliding transition between schematic maps 10, which are suitable for navigation in a line system (e.g., a transportation system such as a subway system), and geographic map 20, which are more suitable for navigation in local places (e.g., in a city), is achieved in a single combined map 30, in which dynamic interpolation between these two map representations is possible, the two maps 10, 20 always being included at least partially in the combined, i.e., integrated map 30.

Such combined maps 30 may be used in a variety of ways:
1) On large static maps, e.g., at a subway station, detailed geographic information may be additionally displayed in a schematic map for this station.
2) A static overview of an integrated map 30, which includes a few annotations of a schematic map, for example, through large roads and a few (essential) landmarks and is thus suitable for an approximate orientation.
3) In an interactive and/or dynamic application, a combination map 30 is stored in a (mobile) terminal (e.g., cellular telephone, PDA) and is represented on a display of the terminal by means of OpenGL and/or GLUT, for example.

FIGS. 3A to 3E show other examples of a nondistorted geographic integrated map 50, 70 (as shown in FIGS. 3A and 3D) and an integrated map, i.e., integrated according to a distorted map on a network plan (and/or with respect to a network plan) (as shown in FIGS. 3B and 3E). In the integrated maps 60, 80, in which geographic elements are shown in distorted form, it is clear that the respective center is enlarged to a greater extent than the periphery. It is clear from this that the warping method with overlap control and/or overlap avoidance, which was applied to the geographic maps 50, 70, causes (essentially) relatively little distortion of regions around the control points and/or reference points (i.e., starting positions and destination positions 51, 53 and 61, 63 and/or 71, 73, 75 and 81, 83, 85), whereas regions between the control points have proportionally greater distortion.

FIG. 3C shows an integrated map 60 in which geographic elements are represented as distorted and schematic elements are represented a rectified (i.e., starting positions of the geographic representation 51, 53, 55, 57 are shifted to destination positions 61, 63, 65, 67 of a schematic representation, and the remaining points in between are uniformly distributed by means of the mapping function described above. Furthermore, FIG. 3C shows a linking of the mapping function to an enlargement function (lens function). The enlargement function is applicable to a single area and/or detail 52, 54 of the integrated map representation. For example, a region 52, 54 around a reference point 55, 57 (for example, a subway station) is enlarged. By applying the enlargement function to this detail 52, 54, the geographic elements contained therein are represented in rectified form and the schematic elements are distorted accordingly (so-called warping lens).

An integrated representation with individual enlarged regions and/or details 52, 54 is advantageous, for example, to obtain an overview of a public transportation system, wherein an environment 52 of a starting position 55 (e.g., the subway station from which a user would like to depart) and an environment 54 around an end position 57 (e.g., the subway station which the user would like to reach) are rectified at the same time, i.e., are represented in geographically correct form in the integrated map 60. For example, such a starting position 55 and/or destination position 57 (i.e., a reference point) for an enlargement from the route calculation and/or a geographic position determined by means of GPS can be determined. Such a reference point may also be a position near a stopping point, for example.

Accordingly, an enlarged geographic representation and/or a rectified or less distorted geographic representation of the integrated map 60, which is otherwise geographically distorted, is shown in the enlarged area 52, 54, and a distorted integrated map 60, which has been distorted according to a schematic representation, is shown outside of the area 52, 54. A center, a radius, a shape or form and/or a level of distortion (or level of rectification) for a region and/or detail of the integrated representation 60 are user-definable and may be linked to other state (e.g., capacities of an output device and/or the geographic position of a user) are linked and/or modified interactively and/or dynamically. In one implementation, an improved transition between an enlarged area 52, 54 and the remaining representation 60 can be created and/or produced. For example, a section of the integrated map 60 can be placed around an enlargement 52, 54 in the background.

In one implementation, in a warping-based mapping of a geographic map 10 a level of detail for the geographic detail is additionally calculated. As described above with respect to FIGS. 2A and 2D, a partially derived function (partial derivation) is estimated and/or calculated for each control point for the overlap control and/or overlap avoidance during an iterative mapping of control points at this point. This estimate is also used for control of the level of detail because the Jacobian determinant J defines a local area enlargement, and the minimum Jₘᵢₙ is proportional to the local compression. Consequently, the local compression may also be calculated from this estimate.

Thus, in addition, to the mere fading in and out of selected and/or selectable elements (e.g., points of certain types of roads and/or landmarks), another representation with a different level of detail, which may take into account the local distortion and/or enlargement effects occurring due to the layout adjustment (in particular in the integrated map 30) is made possible, so that the representation advantageously prevents overwriting with too many details but at the same time is capable of representing as many discernible details as possible, although this is not usually possible with rendered pixel maps in particular. The recognizability and/or the required level of detail depend advantageously on the local enlargement, but this enlargement is in particular not just one factor, i.e., one-dimensional but instead is two-dimensional (i.e., the distorted information may be compressed, i.e., may have different enlargement factors depending on the direction). Accordingly, the level of detail depends in particular on the area enlargement and the compression factor, which can be determined via the approaches of the partial derivations.

Furthermore, to adjust the level of detail in rendering, the thickness d of the lines in the vector data may be altered, specifically as shown below:

d=f₁ (level enlargement)+f₂ (1/compression factor)

f₁ and f₂ in particular are empirically determined functions, which depend on the display size, display resolution and/or a desired “density” of the representation. In the simplest case, the functions may be linear functions with constant parameters (e.g., f₂ (level enlargement)=F₁₋₁*level enlargement+F₁₋₂ with constant values F₁₋₁ and F₁₋₂).

In addition, the thickness of linear cartographic entities (e.g., lines, symbols) is varied in direct proportion to the local area enlargement and indirectly in proportion to their local compression. Consequently, the density of individual cartographic entities is distributed (essentially) uniformly over the entire map (deformed and/or distorted).

In one implementation, a zoom technique is additionally implemented for a combined map 30. This zoom technique couples a scaling of a viewpoint in the combined map and/or map representation 30 with a (dynamic) transition between the basic geographic map and/or map representation 10 and the corresponding schematic map and/or map representation 20. Accordingly, an interpolation is performed between the distorted map 30 and the geographic map 10 while zooming and (essentially) at the same time the map is transformed (i.e., zoomed) in such a way that the center of the map 30 remains at a constant position on the screen. This method, which combines warping and zooming, is known as warping zoom and is illustrated in FIG. 4.

The (preferably linear) interpolation between the two layouts i.e., between the geographic map 10 and the schematic map 20 (in particular the interpolation between the geographic and “schematic” positions of all points) allows a continuous map animation and/or map adaptation which preservers both the index and the context: the focus point (usually the location of the user) preferably remains in a predetermined position (e.g., essentially at the center) of the display during the entire animation and/or variation, so that the user need not be relocated on the map when he changes the map layout situationally. This therefore yields a more intuitive and more easily readable display. Furthermore, the context information may also be preserved because although the surrounding locations are shifted, the embedding of the focus point in the network preferably does not change. Therefore, it is not necessary for a user to also have to determine his orientation again with respect to the new layout (e.g., in the case of a change from a geographic layout, i.e., from geographic map 10 to the schematic subway layout as an example of a schematic map 20, a user will thus recognize immediately which station he is at and in which direction he must travel).

Furthermore, the “intermediate layouts” (i.e., an interpolated state between the geographic and schematic positions of the points) may be beneficial in order to support more complex navigation tasks. Assuming that the user is a pedestrian located at his starting address and would like to find a specific destination address, in the first step the user may select the subway station closest to the starting address as the starting station. Then he can search for the destination address on the map and select the station closest to it as the destination station. Then the user may zoom out and plan, i.e., a select a route between the two selected stations. If there is no direct route (e.g., no route without complicated transfers), the user may search for more direct connections that would connect the approximate starting region to the approximate destination region. If the user has found a favorable connection, he can zoom back into the representation until he can discover the starting address in the system of roads distorted in this way. Then the user can center the map on the starting address and zoom out until a station of the more favorable connection appears in the display. On the basis of this layout, the user can then estimate or recognize more advantageously whether or not this alternative starting station is located at a reasonable walking distance from the starting station. If the user believes he has found an alternative, he can zoom in completely and check his assessment for whether the actual distance can be reached on foot. The same procedure can also be applied to selecting the destination station. By flexible handling of zooming in and zooming out, it is thus possible to search for alternative connections and alternative starting stations and/or destination stations, so that the graphical user interface is made more intuitive and easier for the user to handle.

The zoom factor describes a ratio between a point at the greatest distance and a point at the shortest distance (closest point). In zooming, only one detail of an integrated map 30, for example, is altered but the perspective is not altered. Consequently, the user will zoom in and zoom out starting from a fixedly selected point, for example, a midpoint of the integrated map 30 on a display. In zooming in, a detail of the integrated map 30 is shown in enlarged form, e.g., integrated map 30-4, 30-8. In zooming out, a detail of the integrated map 30 is shown on a reduced scale, e.g., integrated maps 30-7 and 30-1.

A representation of an integrated map 30 comprises a geographic map representation 10 and a schematic map representation 10 [sic; 20] of the same map detail, wherein at least one of the two map representations is distorted as a function of a degree of distortion. In an extreme case, the schematic map representation 20 may be distorted (essentially) completely with regard to the geographic representation 10. This extreme case is illustrated in maps 30-1, 30-10, 30-9 and 30-8. Thus the schematic positions 21, 23, 25, 27, 29 are then mapped accordingly on the geographic positions 11, 13, 15, 17, 19, and the points in between are distributed continuously according to the mapping function defined above. In another extreme case, the geographic map representation 10 may be distorted (essentially) completely with regard to the schematic map representation 20. This extreme case is shown in maps 30-4, 30-5, 30-6 and 30-7. Thus the geographic positions 11, 13, 15, 17, 19 are then mapped accordingly on the schematic positions 21, 23, 25, 27, 29, and the points in between are distributed continuously according to the mapping function defined above.

In a distorted representation of the schematic and/or geographic map representations 10, 20 in the integrated map 30, parts and/or elements e.g., cartographic entities such as inscriptions, superimposed lines, rivers, roads, public buildings, facilities and/or parks of the geographic map representation 10 and/or the schematic map representation 20 may be at least partially no longer visible.

In addition, or in combination with a degree of distortion, a zoom factor may be selected for a display of the integrated map. The maximum zoom-in factor (a maximum enlargement) and a maximum zoom-out factor (a maximum reduction) of a detail of the integrated map 30 may be selected for the zoom factor. A combination of distortion (warping) and zooming of the integrated map 30 allows a higher interactivity with the integrated map 30. Zooming and warping mutually influence one another. The greater the zoom-in, the less is the schematic and/or geographic component of the integrated map 30 distorted (or warped), i.e., the integrated map 30 has even greater rectification. And conversely, the farther out the zoom-out goes, the greater is the schematic and/or geographic component of the integrated map 30. Distorted, i.e., the lesser the extent to which the integrated map 30 is rectified.

To select a representation of an integrated map 30 with a certain degree of distortion and a certain zoom factor, such as 30-1 to 30-10, for example, a user may manipulate the integrated map interactively. For example, a user may select a zoom factor and/or a degree of distortion by using suitable control means (e.g., a cursor) on a display of the integrated map 30 and/or one or more operating elements (e.g., a button on a terminal, a scroll bar, a menu selection integrated into a display of the integrated map 30).

As shown in FIG. 4, both maps 10, 20 (i.e., the schematic map and the geographic map) are at least partially visible in each representation, regardless of the degree of distortion and/or the zoom factor in a representation of the integrated map. For example, 30-1 [sic; FIG. 4] shows an integrated map 30-1, in which a geographic map 10 has been distorted completely onto a schematic map 20 without zooming in on the display, i.e., there is not only one detail in an enlarged view. In zooming in to the integrated map 30-1, 30-10, 30-9 to 30-8, which is purely schematic (i.e., the schematic component and/or the schematic elements are not distorted), the integrated map 30 is rectified by zooming, i.e., the schematic and/or geographic component of the integrated map 30 is shown with less distortion. Consequently, a schematic representation with a high zoom factor of the integrated map 30-8 (i.e., the schematic component and/or the schematic elements are not distorted) will be less distorted than an overview of the schematic representation of the integrated map 30-1 with little or no zoom. Integrated maps 30-1, 30-2, 30-3 to 30-4 show a combined application of a degree of distortion and a zoom factor to the integrated map 30, wherein the degree of distortion is the greatest in map 30-1 and is the lowest in map 30-4. The degree of distortion thus denotes how greatly a geographic representation, which is integrated into the integrated map, has been adapted to a schematic representation integrated into the map 30 or has been distorted. By coupling with a zoom factor, the schematic representation in the integrated map 30-4 has little or no distortion due to the zoom factor in the greatly enlarged, i.e., zoomed integrated map 30-4, in which the geographic representation has little or no distortion, but there is distortion in an integrated overview map 30-7 in which the geographic representation has little or no distortion.

In other words, FIG. 4 shows various representations of an integrated map 30 in which either the schematic elements of the map 30-4, 30-5, 30-6, 30-7 are distorted or rectified (i.e., warped), the geographic elements of the map 30-8, 30-9, 30-10, 30-1 are distorted or rectified (i.e., warped) and/or both elements of the map 30-2, 30-3, 30-4 are distorted or rectified (i.e., warped). In addition to such a degree of distortion, a zoom factor can be applied to the integrated map 30 in a combination. A zoom-in is performed from an overview map 30-1, 30-7 to a detailed map 30-4, 30-8, wherein a degree of distortion is possibly also selected with respect to the geographic elements of the map 30-2, 30-3. Map 30-4 shows a geographically rectified integrated map with maximum zoom-in, in which the schematic map has little or no distortion due to the zoom factor. Zooming out of the integrated map 30-4 without any change in the degree of distortion is illustrated, for example, by maps 30-5, 30-6, in which the integrated map 30-7 then shows an integrated map 30-7 with maximum zoom-out, wherein the geographic elements of the map 30-7 are rectified. Consequently, the schematic elements of the map 30-7 are relatively greatly distorted. If a distortion factor of the geographic elements is also applied to the integrated map 30-4, in addition to zooming out of the integrated map 30-4, then an integrated map in which the schematic elements have little or no distortion and the geographic elements have relatively great distortion can be displayed via maps 30-3, 30-2, 30-1. If the user now zooms into this map 30-1, e.g., by way of maps 30-10, 30-9, then the geographic elements are relatively rectified as a function of the distortion factor. The integrated map 30-8 then shows an integrated map 30 in which the schematic elements have little or no distortion and the geographic elements have relatively great rectification as a function of the zoom factor. However, map 30-1 shows the geographic elements with relatively little rectification, i.e., with relatively great distortion, as a function of a small zoom factor.

Consequently, the degree of distortion and the zoom factor of an integrated map 30 are (essentially) in inverse proportion to one another. If the zoom factor increases (thus if a map detail is enlarged and thereby becomes more detailed) at the same degree of distortion, then the elements (schematic and/or geographic) represented as distorted in the integrated map 30 are less distorted, i.e., more rectified in relation to the zoom factor. If the degree of distortion increases (i.e., if the geographic elements and/or the schematic elements become more distorted) at the same zoom factor, then only the distortion and/or rectification changes accordingly.

A starting value and/or a final value for the scaling factor of the map 30 can be selected because, depending on the selected output device (e.g., cellular telephone, PDA, mobile navigation device) and in particular depending on the size and/or resolution of the display of the display device and/or the size of integrated map, not all representations 30-1 to 30-10 of the integrated map 30 can be displayed appropriately. For example, a rectified (geographic) map 30-4 is shown only if it has been enlarged, i.e., high degree of zoom and thus only individual stations are displayed. If a level of detail which denotes how many details of cartographic entities (e.g., roads, rivers, public buildings and/or installations) are additionally displayed, accuracy being additionally selected therein, the integrated map 30 remains readily readable and understandable for a user in any representation 30-1 to 30-10. For example, only large and/or important cartographic entities (e.g., rivers and main roads) of the distorted geographic representation are displayed in an approximate representation 30-1 of an integrated map 30 having a high degree of distortion.

A representation of a combined map 30 with warping zoom is advantageous in particular only on mobile terminals having a small screen and/or low resolution. If a user zooms out of the interactive map (into a schematic map with fewer details), then he gets an approximate overview 30-1 of a city, for example, and its public transportation system. If the user leaves the public transportation system at a station and wants to reach a location near the station, he can zoom in on this station at the same time and select a geographic representation of the map 30-4. Since only individual stations are shown in the zoomed map 30b, the combined map 30b is neither distorted nor represented schematically on the display screen.

In one implementation, a starting value and a scaling value for the warping method and/or the warping zoom method are shown as a function of a map to be represented and/or a display screen size. If a suitable level of detail is defined, then the representation remains readable and/or displayable for a (mobile) terminal with any change in a distortion factor and/or zoom factor.

For example, geographic proximity to a subway station or another cartographic entity can then be scaled automatically.

With reference to FIGS. 5 and 6, a schematic map 10 with isolines is annotated at certain distances from a nearest position. In general, isolines are understood to be lines (in geographic or schematic maps) which carry a value, such that isolines connect locations of the same value. The value denotes, for example, a certain distance between two points. Isolines can be calculated by interpolation.

As shown in FIG. 5, the warping method is then applied to individual grid points 91, 93, 95 so, that a distorted grid 90 is calculated as shown in FIG. 5. The real (i.e., geographically correct) distances from the individual positions to the corresponding next position 101, 103, 105 are represented in a combined map 100 by first distances from each grid 91, 93, 95 to the next position 101, 103, 105 [sic]. Then a “marching squares” method is applied to the distorted grid 90, calculating isolines in the corresponding combined map 100 corresponding to the distances from the nearest station in the real world, as shown in FIG. 6. For example, with the help of a map 100 annotated in this form, the next station to a certain destination can be determined easily.

The type of representation described here (in particular the warping zoom functionality comprising a combination of the layout interpolation with the viewing parameters and the level of detail) can be implemented advantageously on a multitouch display (for example, that of an Apple iPhone, a PAD or the like). The zoom factor can be adjusted here on computer-implemented maps by two-finger interaction on a multitouch display. The user then touches the display with two fingers simultaneously at positions that are farther apart on the map and next brings his two fingers together to reduce the size of the map. The map is enlarged if the user touches positions on the map that are very close together and then moves his two fingers apart. In conjunction with the warping zoom functionality on a multitouch display in particular, the level of detail can advantageously be combined with control of the enlargement factor, so that the zoom functionality, i.e., the control of the level of detail can be controlled, i.e., adjusted by moving two fingers in a predetermined first direction (e.g., in the vertical direction) on the map, while the warping functionality (i.e., the degree of distortion) an be altered or controlled by moving the fingers in a second direction which is different from the first (e.g., in the horizontal direction).

In particular there are virtually two coordinate axes (preferably perpendicular to one another, i.e., X axis: horizontal, Y axis: vertical) in a multitouch display, their values ranging from 0 to 1, for example. When the user's fingers move toward one another, the enlargement factor is reduced by the distance between the two fingers which is reduced in Y direction. With the opposite movement of the fingers, the enlargement factor increases accordingly. The interpolation between the geographic and schematic positions of the data points (i.e., the interpolation between the geographic map 10 and the schematic map 20) is preferably also controlled by a two-finger interaction. To do so, the user's fingers may move horizontally toward one another or away from one another. If the fingers move toward one another, the weight of the schematic positions is increased by the distance between the two fingers, which is reduced in X direction, and the weight is reduced by the same value for the geographic positions. With the opposite movement of the fingers, the weight for the schematic positions is reduced and the weight for the geographic positions is increased accordingly. These two two-finger interactions (vertically: viewing parameters with level of detail, horizontally: warping) are combined advantageously, so that the two fingers move diagonally on the display (i.e., at angles to the first and second directions different from 0° and 180°). The distance changes (e.g., is reduced) accordingly in both X and Y directions with the diagonal movement, so that both changes in distance can be applied at the same time to the display parameters with level of detail (Y direction) and warping (X direction), as described above. Thus, if the fingers move diagonally, the result is advantageously a combined and/or simultaneous control, i.e., adjustment of the two zoom distortion and warping functionalities as so-called warping zoom.

In other words, by two-finger operation in the first direction, the zoom functionality can be controlled and by two-finger operation in the second direction the distortion, i.e., warping functionality can be controlled and by two-finger operation in a third direction at an angle to the first and second directions, a combination of zoom and warping functionality can be controlled. Therefore, this yields a very simple and intuitive possibility for interaction and/or adjustment for the user.

Furthermore, on devices with receivers for satellite navigation signals (navigation system in an automobile, cellular phone, PDA), position information about the current location, speed information and/or acceleration information may advantageously be made available, so that at least some of this information can be used for (preferably automatic) control of the warping zoom functionality. Thus, for example, at a high speed on the highway, the device is able to display only the long-distance road system, whereas after the exit, a detailed road map can be displayed. If the satellite signal is interrupted, e.g., on entering a subway station, the display shows the network plan as a schematic map 20. When the user reaches the surface again, the display of a geographic map 10, which is situationally matched to a pedestrian tempo or an integrated map 30, is displayed (e.g., a city map with all buildings, passages and alleys).

With reference to FIG. 7, an exemplary system for implementing the invention will now be described. An exemplary system comprises a universal computer system in the form of a traditional computer environment 120, e.g., a personal computer (PC) 120 having a processor unit 122, a system memory 124 and a system bus 126 connecting a plurality of system components, among others the system memory 124 and the processor unit 122. The processor unit 122 can perform arithmetic, logic and/or control operations by accessing the system memory 124. The system memory 124 can store information and/or instructions for use in combination with the processor unit 122. The system memory 124 may include volatile and nonvolatile memories, for example, a random access memory (RAM) 128 and a read-only memory (ROM) 130. A basic input-output system (BIOS), which contains the basic routines that help to transfer information among the elements within the PC 120, for example, while booting up the system, may be stored in ROM 130. The system bus 126 may be one of many bus structures, including a memory bus or a memory controller, a peripheral bus and a local bus, which uses a certain bus architecture from a plurality of bus architectures.

PC 120 may also have a hard drive 132 for reading or writing a drive (not shown) and an external disk drive 134 for reading or writing a removable disk 136 and/or a removable data medium. The removable disk may be a magnetic disk and/or a magnetic diskette for a magnetic disk drive and/or a diskette drive or an optical diskette, e.g., a CD-ROM for an optical disk drive. The hard drive 132 and the external disk drive 134 are each connected to the system bus 126 via a hard drive interface 138 and an external disk drive interface 140. The drives and the respective computer-readable media make available computer-readable instructions, data structures, program modules and other data for the PC 120 to a nonvolatile memory. The data structures may have the relevant data for implementing a method as described above. Although the environment described as an example uses a hard drive (not shown) and an external disk 142, it will be obvious for this skilled in the art that other types of computer-readable media which are capable of storing computer-accessible data may be used in the exemplary operating environment, e.g., magnetic cassettes, flash memory cards, digital video diskettes, random access memories, read-only memories, etc.

A plurality of program modules, in particular an operating system (not shown), one or more application programs 144 or program modules (not shown) and program data 146 may be stored on the hard drive, the external disk 142, the ROM 130 or the RAM 128. The application programs may comprise at least a portion of the functionality as shown in FIG. 7.

A user may enter commands and information as described above into the PC 120 on the basis of input devices, e.g., a keyboard 148 and a computer mouse and/or a trackball 150. Other input devices (not shown) may include a microphone and and/or sensors, a joystick, a game pad, a scanner or the like. These or other input devices may be connected to the unit 122 on a the basis of a serial interface 152 which is connected to the system 126 or they may be connected via other interfaces, e.g., a parallel interface 154, a game port or a universal serial bus (USB). In addition, information can be printed using a printer 156. The printer 156 and other parallel input output devices may be connected to the processor unit 122 by the parallel interface 154. A monitor 158 or other types of display(s) is/are connected to the system bus 126 by means of an interface e.g., a video input/output 160. In addition to the monitor, the computer environment 120 may also include other peripheral output devices (not shown), e.g., loudspeakers or acoustic outputs.

The computer environment 120 may communicate with other electronic devices, e.g., a landline telephone, a cordless telephone, a personal digital assistant (PDA), a television or the like. To communicate, the computer environment 120 may operate in a networked environment using connections to one or more electronic devices. FIG. 7 shows the computer environment networked with a remote computer 162. The remote computer 162 may be another computer environment, e.g., a server, a router, a network PC, an equivalent or peer device or other conventional network nodes and may comprise many or all of the elements described above with regard to the computer environment 120. The logic connections such as those shown in FIG. 7, comprise a local area network (LAN) 164 and wide area network (WAN) 166. Such network environments are customary in offices, company-wide computer networks, intranets and the Internet.

When a computer environment 120 is used in a LAN network environment, the computer environment 120 may be connected to the LAN 164 by a network input/output 168. If the computer environment 120 is used in a WAN network environment, the computer environment 120 may include a modem 170 or other means for establishing communication via the WAN 166. The modem 170 which may be internal and external with respect to the computer environment 120 is connected to the system bus 126 by means of the serial interface 152. Program modules which are represented in relation to the computer environment 120, or sections thereof may be stored in a remote memory device, which is accessible on or from a remote computer 162, in the network environment. In addition, other data which are relevant for the method and/or system described above may be accessible on or from the remote computer 162. Furthermore, it is possible to connect a system for dynamic integration of a geographic map representation and a schematic map representation to a navigation position receiver (e.g., GPS receiver), so that a zoom factor and/or a degree of distortion of an integrated map can be determined automatically by the system as a function of a geographic position, for example.

### LIST OF REFERENCE NUMERALS

10; 50; 70 Geographic map representation
11-19; 51, 53; 71, 73 Starting positions
14, 16 Isolines
20; 60; 80 Schematic map representation
21-29; 63, 65; 81, 83 Destination positions
22-28 Connection
30; 100 Integrated map representation
90 Distorted grid
91, 93, 95 Grid points
101, 103,105 Geographic (starting) positions
111, 113, 115 Isolines
120 Computer environment
122 Processor unit
124 System memory
126 System bus
128 Random access memory (RAM)
130 Read-only memory (ROM)
132 Hard drive
134 Disk drive
136 Removable disk
138 Hard drive interface
140 Disk drive interface
142 External disk
144 Application program
146 Program data
148 Keyboard
150 Computer mouse/trackball
152 Serial interface
154 Parallel interface
156 Printer
158 Monitor
160 Video input/output
162 Remote computer
164 Local area network (LAN)
166 Wide area network (WAN)
168 Network input/output

1.-18. (canceled)

19. A computer-implemented method for dynamic integration of a geographic map representation and a schematic map representation, the method comprising:
providing a geographic map representation having one or more starting positions, which are assigned to one or more destination positions in a schematic map representation;
calculating an interpolating and continuous mapping function by applying a warping method using the starting positions and the destination positions as reference points associated with a method for overlap control; and
displaying a dynamically and/or interactively integrated map representation by dynamic application of the mapping function to the geographic map representation and/or the schematic map representation, so that the respective map representation is distorted according to a selected distortion factor, wherein the integrated map representation represents at least elements and/or parts of both the geographic map representation and the schematic map representation, regardless of the distortion factor selected.

20. The method according to claim 19, wherein displaying the integrated map representation includes:
displaying the dynamically and/or interactively integrated map representation by applying a zoom function coupled with the mapping function to the geographic map representation and/or the schematic map representation.

21. The method according to claim 20, wherein applying the zoom function coupled with the mapping function includes:
dynamically interpolating between the geographic map representation and the schematic map representation by applying the mapping function with simultaneous application of the zoom function, wherein the center of the integrated map representation remains at a constant representation position.

22. The method of claim 21, wherein the interpolation between the geographic map representation and the schematic map representation is a linear interpolation.

23. The method of claim 19, further comprising:
displaying the dynamically and/or interactively integrated map representation by applying the mapping function coupled to an enlargement function, which is applicable to a detail of the integrated map representation.

24. The method of claim 19, further comprising:
calculating a level of detail according to selection and/or resolution for the integrated map representation as a function of an output unit and/or the degree of distortion.

25. The method of claim 24, further comprising:
displaying the dynamically and/or interactively integrated map representation by applying the mapping function coupled to the level of detail according to the selection and/or resolution and/or the enlargement function as a function of a geographic position and/or a movement by a user.

26. The method of claim 19, further comprising:
calculating and representing distance information in the integrated map representation.

27. The method of claim 26, wherein calculating and representing the distance information in the integrated map representation further includes: distorting a regular grid with simultaneous application of the mapping function to the geographic map representation by applying the mapping function to one or more grid points of the grid; and
representing the distance information by isolines in the integrated map representation by calculating the distance from each of the grid points to the corresponding next geographic position in the geographic map representation and applying the warping method to the first grid.

28. A computer system for dynamic integration of a geographic map representation and a schematic map representation, the system comprising:
a memory device configured to store a geographic map representation having one or more starting positions that are assigned to one or more destination positions in a schematic map representation;
a data processing device configured to calculate an interpolating and continuous mapping function by applying a warping method using the starting positions and the destination positions as reference points associated with a method for overlap control; and
a display configured to represent a dynamically and/or interactively integrated map representation by dynamic application of the mapping function to the geographic map representation and/or the schematic map representation, so that the respective map representation is distorted according to a selected distortion factor, wherein the integrated map representation represents at least elements and/or parts of both the geographic map representation and the schematic map representation regarding of the distortion factor selected.

29. The system of claim 28, wherein the display is further configured to display the dynamically and/or interactively integrated map representation by applying a zoom function coupled to the mapping function to the geographic map representation and/or the schematic map representation.

30. The system of claim 29, wherein the display is further configured to interpolate dynamically between the geographic map representation and the schematic map representation by applying the mapping function with simultaneous application of the zoom function, wherein the center of the integrated map representation remains at a constant position in the representation.

31. The system of claim 28, wherein the display is further configured to display the dynamically and/or interactively integrated map representation by applying the mapping function coupled to an enlargement function which is applicable to a detail of the integrated map representation.

32. The system of claim 28, wherein the data processing device is further configured to calculate a level of detail according to selection and/or resolution for the integrated map representation as a function of an output device and/or the degree of distortion.

33. The system of claim 32, wherein the display is further configured to display the dynamically and/or interactively integrated map representation by applying the mapping function coupled to the level of detail according to selection and/or resolution and/or the enlargement function as a function of a geographic position and/or a movement by a user.

34. The system of claim 28, wherein the data processing device is further configured to calculate distance information in the integrated map representation (30) and to show it on the display.

35. The system of claim 34, wherein the data processing device is further configured:
to distort a regular grid with simultaneous application of the mapping function to the geographic map representation by applying the mapping function to one or more grid points of the grid; and
to represent the distance information by isolines in the integrated map representation by calculation of a distance from each of the grid point to a corresponding next geographic position in the geographic map representation and applying the warping method to the distorted grid on the display.

36. A display of an integrated map representation as a dynamic integration of a geographic map representation and a schematic map representation, wherein:
the dynamically and/or interactively integrated map representation is displayed by dynamic application of a mapping function to a geographic map representation having one or more starting positions, which are assigned to one or more destination positions in a schematic map representation, and/or to the schematic map representation, so that the respective map representation is distorted according to a selected distortion factor,
the interpolating and continuous mapping function has warp processing using the starting positions and the destination positions as reference points in combination with an overlap control, and
the integrated map representation represents at least elements and/or parts of the geographic map representation as well as the schematic map representation, regardless of the selected distortion factor.

37. A computer program product, stored in a computer-readable medium, which, when loaded into the memory of a computer or a computer network and executed by a computer or a computer network, causes the computer or the computer network to dynamically integrate a geographic map representation and a schematic map representation by:
providing a geographic map representation having one or more starting positions, which are assigned to one or more destination positions in a schematic map representation;
calculating an interpolating and continuous mapping function by applying a warping method using the starting positions and the destination positions as reference points associated with a method for overlap control; and
displaying a dynamically and/or interactively integrated map representation by dynamic application of the mapping function to the geographic map representation and/or the schematic map representation, so that the respective map representation is distorted according to a selected distortion factor, wherein the integrated map representation represents at least elements and/or parts of both the geographic map representation and the schematic map representation, regardless of the distortion factor selected.

38. The computer program product of claim 37, wherein displaying the integrated map representation includes:
displaying the dynamically and/or interactively integrated map representation by applying a zoom function coupled with the mapping function to the geographic map representation and/or the schematic map representation.

39. The computer program product of claim 38, wherein applying the zoom function coupled with the mapping function includes:
dynamically interpolating between the geographic map representation and the schematic map representation by applying the mapping function with simultaneous application of the zoom function, wherein the center of the integrated map representation remains at a constant representation position.

40. The computer program product of claim 39, wherein the interpolation between the geographic map representation and the schematic map representation is a linear interpolation.

41. The computer program product of claim 37, which, when loaded into the memory and executed by the computer or the computer network, further causes the computer or the computer network to:
display the dynamically and/or interactively integrated map representation by applying the mapping function coupled to an enlargement function, which is applicable to a detail of the integrated map representation.

42. The computer program product of claim 37, which, when loaded into the memory and executed by the computer or the computer network, further causes the computer or the computer network to:
calculate a level of detail according to selection and/or resolution for the integrated map representation as a function of an output unit and/or the degree of distortion.

43. The computer program product of claim 42, which, when loaded into the memory and executed by the computer or the computer network, further causes the computer or the computer network to:
display the dynamically and/or interactively integrated map representation by applying the mapping function coupled to the level of detail according to the selection and/or resolution and/or the enlargement function as a function of a geographic position and/or a movement by a user.

44. The computer program product of claim 37, which, when loaded into the memory and executed by the computer or the computer network, further causes the computer or the computer network to:
calculate and represent distance information in the integrated map representation.

45. The computer program product of claim 44, wherein calculating and representing the distance information in the integrated map representation further includes:
distorting a regular grid with simultaneous application of the mapping function to the geographic map representation by applying the mapping function to one or more grid points of the grid; and
representing the distance information by isolines in the integrated map representation by calculating the distance from each of the grid points to the corresponding next geographic position in the geographic map representation and applying the warping method to the first grid.
